(19) United States
(12) Patent Application Publication
(10) Pub. No.: US 2012/0064350 A1
(43) Pub. Date: Mar. 15, 2012

(54) INTERMEDIATE TRANSFER BELT, IMAGE FORMING APPARATUS, AND METHOD FOR PRODUCING THE INTERMEDIATE TRANSFER BELT

(75) Inventors: Akihiro HONYA, Kanagawa (JP); Toshio TOKUYASU, Hyogo (JP); Junji UJIHARA, Tokyo (JP); Tadaaki SUMITANI, Tokyo (JP)

(73) Assignee: KONICA MINOLTA BUSINESS TECHNOLOGIES, INC., Tokyo (JP)

(21) Appl. No.: 13/221,760

(22) Filed: Aug. 30, 2011

(30) Foreign Application Priority Data
Sep. 10, 2010 (JP) 2010-202804

(51) Int. Cl. B32B 9/04; G03G 15/01

(52) U.S. Cl. 428/411.1; 399/302

(57) ABSTRACT

An intermediate transfer belt for use in an image forming apparatus of an electro-photographing type, includes a substrate; and a surface-cured layer provided on the substrate; wherein the surface-cured layer contains a reaction product of at least an active energy ray curable monomer, reactive metal oxide particles, and a graft copolymer of a polymerizable fluorine resin and a polymerizable siloxane.

This application is based on Japanese Patent Application No. 2010-202804 filed on Sep. 10, 2010, in Japanese Patent Office, the entire content of which is hereby incorporated by reference.

### BACKGROUND OF THE INVENTION

The present invention relates to an intermediate transfer belt for use in an image forming apparatus of an electro-photographing type, an image forming apparatus, and a method for producing the intermediate transfer belt.

In recent years, the image forming apparatuses of electro-photographing type, such as a copying machine and a laser printer, are requested strongly to realize high quality full color image, and quality improvement. As well-know conventionally, the image forming apparatuses of electro-photographing type include a charge member to uniformly charge a photoreceptor; an exposure member to form an electrostatic latent image on the photoreceptor a development member to develop the electrostatic latent image into a toner image; a transfer member to transfer the toner image onto a transfer sheet; a fixing member to fix the toner image on the transfer sheet, a cleaning member to clean the remaining toner on the photoreceptor; and an electric charge eliminating member to eliminate electrostatic latent images on the photoreceptor. Some of the image forming apparatuses of electro-photographing type supply electrically-charged toner to an electrostatic latent image on a photoreceptor via a contact manner or a non contact manner, visualize the electrostatic latent image into a toner image through a development process, firstly transfer the toner image from the photoreceptor onto an intermediate transfer member in a transfer process, then secondarily transfer the toner image from the intermediate transfer member onto a transfer sheet (for example, paper sheet), and further fixes the toner image to form a final image.

In the transfer process, an intermediate transfer member receives various mechanical or electrical forces, such as transfer charging and charge eliminating in order to firstly transfer a toner image onto the intermediate transfer member, and cleaning by a blade into remove toner remaining on the intermediate transfer member after the transferring.

For this reason, in the case where an intermediate transfer belt is employed as the intermediate transfer member, the intermediate transfer belt is required to respond to the following requests which are typical items in order to attain high quality image and high image production rate.

1) High Transfer Ratio when a Toner Image Formed on the Surface of an Intermediate Belt is Transferred onto a Transfer Sheet.

The transfer ratio means a ratio of a toner image formed on the surface of an intermediate belt to a toner image transferred onto a transfer sheet. A low transfer ratio causes image omission in an image transferred onto a transfer sheet and image density unevenness, so that a high image quality cannot be realized.

### 2) High Durability

The durability means a performance to make it possible to transfer a toner image onto a transfer sheet for a long period of time. After a toner image is transferred from an intermediate transfer belt to a transfer sheet, the intermediate transfer belt is scraped by a cleaning belt so as to remove remaining toner. The scraping by the cleaning belt lowers the smoothness of the surface of the intermediate transfer belt, and causes flaws and cracks on the surface, so that toner images cannot be transferred stably from the intermediate transfer belt. Further, the belt rotation causes cracks on the surface of the intermediate transfer belt.

### 3) No Filming

Filming means a phenomenon that after a toner image is transferred from an intermediate transfer belt to a transfer sheet, when the surface of the intermediate transfer belt is cleaned by a cleaning belt, remaining toner which is not removed at the time of cleaning is accumulated gradually in the form of film. The causes of the remaining toner may be considered as follows. 1) Toner comes in cracks taking place on the surface of the intermediate transfer belt. 2) Toner remains in concave portions formed in the surface of the intermediate transfer belt by the scraping of the cleaning blade.

At the places where filming take places, the transfer ratio decreases, and streaks and unevenness take place on images, so that high quality image cannot be formed.

Hitherto, various studies have been made for such requests 1) through 3) for the intermediate transfer belt.

Examples of materials used for the intermediate transfer belt, include polycarbonate resin, PVDF (polyvinylidene fluoride), polyalkylene phthalate, a blend material of PC (polycarbonate)/PAT (poly alkylene terephthalate), a blend material of ETFE (an ethylene-tetrafluoroethylene copolymer)/PC, a blend material of ETFE/PAT, a blend material of PC/PAT, and a material in which conductive materials, such as carbon black are dispersed in thermoplastic resins, such as a polyimide resin. In the case where these thermoplastic resins are used for the above requests 1) through 3), such resins are inferior in slipping ability, flaw resistance, and cleaning ability when being used solely. Therefore, it is well known to provide a surface layer on the intermediate transfer belt made of them in order to supplement the above inferior points.

On the other hand, in order to improve a transfer ratio, inorganic particles, magnetic powder, ferrite, or the like are mixed in toner. If such toner is used, even in the case of an intermediate transfer belt which is made of thermoplastic resin and provided with a surface layer, scratches are caused by toner when toner remaining on the intermediate transfer belt after the secondarily-transferring is removed by a blade. Such scratches are one of causes which lower the durability of the intermediate transfer belt.

For this reason, countermeasures to improve the durability of the surface layer have been studied.

For example, a well-known intermediate belt is provided with a resin cured film which is formed by coating on a substrate in order to perform a cleaning ability stably, contains conductive particles and has a thickness of 0.5 μm to 3 μm, (for example, refer Patent Document 1).

However, it turns out that the wear resistance against a blade, the durability against scratches and flaws are surely improved with the technique described in Patent Document 1, but the intermediate belt is inferior in transfer ratio and cleaning ability.

As countermeasures for the wear resistance and the filming phenomenon, a well-know intermediate transfer belt is provided with a three layer structure composed of (a) a substrate layer made of resin, (b) an elastic layer containing a rubber elastic resin, and (c) a surface layer containing a fluorine resin and a laminar clay mineral, wherein a blend ratio of the laminar clay mineral is 1% by weight to 5% by weight and the thickness of the surface layer is 0.5 μm to 4 μm, (for example, refer Patent Document 2).

However, it turns out that in the technique described in Patent Document 2, the resin in the surface layer is not cross-linked, and further laminar clay mineral is not bonded chemically so that the strength is low and the durability is inferior.

Another well-know intermediate transfer belt is provided with a three layer structure composed of a substrate, an elastic layer, and a surface layer, wherein the surface layer includes a rubber latex including 1 to 5 parts by weight of a fluorine rubber to 1 part by weight of a fluorine resin and a curing agent, or a water-based urethane resin including a fluorine resin and silicone component and a curing agent, and the surface layer has a surface energy of 20 mN/m to 40 mN/rn and a 3 μm-indentation hardness of 0.1 MPa to 1.5 MPa measured by a nano-indenter, (for example, refer Patent Document 3).

However, it turns out that in the technique described in Patent Document 3, since the surface layer is structured only by resin components, the surface layer is inferior physically in flaw resistance, and when a relatively strong stress is applied, the durability is low.

Under the above circumstances, desired is the development of an intermediate transfer belt with a surface layer which is excellent in durability such as wear resistance and flaw resistance against removing of toner by a blade after the secondarily transferring; an image forming apparatus; and a method for producing the intermediate transfer belt.
Patent document 1: Japanese Unexamined Patent Publication No. 2007-183401, official report
Patent document 2: Japanese Unexamined Patent Publication No. 2009-258715, official report
Patent document 3: Japanese Unexamined Patent Publication No. 2010-15143, official report

### SUMMARY OF INVENTION

The present invention has been achieved in view of the above circumstances, and an object of the present invention is to provide an intermediate transfer belt with a surface layer which is excellent in a transfer ratio at the time of the secondarily transferring, durability such as wear resistance and flaw resistance against removing of toner by a blade after the secondarily transferring, and filming resistance; an image forming apparatus; and a method for producing the intermediate transfer belt.

The above object of the present invention can be achieved by the following structures.

An intermediate transfer belt for use in an image forming apparatus of an electro-photographing type, comprising:

a substrate; and

a surface-cured layer provided on the substrate;

wherein the surface-cured layer contains a reaction product of at least an active energy ray curable monomer, reactive metal oxide particles, and a graft copolymer of a polymerizable fluorine resin and a polymerizable siloxane.

### BRIEF DESCRIPTION OF THE DRAWINGS

FIG. 1 is an outline cross-sectional structural diagram showing an example of an image forming apparatus of an electro-photographing system which employs an intermediate transfer belt as an intermediate transfer member.

FIG. 2 is a partially-enlarged outline cross sectional view of an intermediate transfer belt of an intermediate transfer member shown in FIG. 1.

FIGS. 3a and 3b are diagrams showing an outline manufacturing process which manufactures the intermediate transfer belt shown in FIG. 2.

FIGS. 4a and 4b are outline diagrams showing an example of a cure processing device of the surface layer (protective layer) used at a cure treatment process shown in FIG. 3.

### DETAILED DESCRIPTION OF PREFERRED EMBODIMENTS

Hereafter, preferred embodiments of the present invention will be explained.

As a result of the studies by the present inventors about the reason why an intermediate transfer belt is inferior in durability, such as wear resistance and flaw resistance against removing of toner by a blade even though the intermediate transfer belt is provided with a surface layer containing a fluorine resin, the following matters become clear.

1. When toner is removed by a cleaning member such as a blade or a brush, since the surface layer is scraped by the cleaning member, the surface layer gets worn. In the state that the blade is pressed onto the surface, toner is nipped between the blade and the surface, and the surface layer is shaven by the nipped toner with the relative movement of the surface layer, which results in flaws.
2. When toner is removed by a blade or a brush, stress is applied in concentration at contact portions between the blade and the surface of the intermediate transfer belt by the blade being pressed toward the surface. At this time, if the intermediate transfer belt is bad at the releasing ability for toner, when toner and external additives are pressed toward the intermediate transfer belt, the toner and external additives cause filming to cover locally the intermediate transfer belt.
3. When toner is secondarily transferred from the intermediate transfer belt to a transfer sheet such as paper, if sticking power between toner and the intermediate transfer belt is strong, the toner is not transferred to the transfer sheet and remains on the intermediate transfer belt, which results in low transfer ratio.

It is presumed that the above phenomena 1 through 3 are caused due to the reasons that the slipping ability of the surface layer becomes low as the surface layer is being used for a long period of time.

As a result of studies the reasons why the slipping ability of the surface layer becomes low as the surface layer is being used for a long period of time, the reason is presumed due to the facts that a part of the fluorine resin constituting the surface layer is separated away due to the loads (refer to the above phenomena 1 through 3) applied to the surface layer.

From the above facts, it turns out that, in order to improve the wear resistance against the blade at the time of transferring, simultaneously, the scratch and flaw resistance against toner, the filming resistance by increasing the releasing ability of the intermediate transfer belt, and a transfer ratio by lowering sticking power between toner and the intermediate transfer belt, it is important to make the surface layer to the following structures.

1. In order to improve the wear resistance, the slipping ability and hardness of the surface layer are made high.
2. In order to raise the slipping ability, it is effective to use a fluorine resin.
3. The fluorine resin is to be prevented from being separating away.

As a result of further studies, factors which influence most the durability of the surface layer are the shortage of the hardness of the surface layer and the separation of the fluorine resin. Accordingly, the inventor conceived that the object of the present invention can be attained by improving the wear resistance against the blade and the scratch and flaw resistance against toner, balancing the hardness and the fiction coefficient so as to prevent the separation of the fluorine resin, and fixing the fluorine resin so as to make respective materials constituting the surface layer into a single structure, and the inventor achieved the present invention.

Namely, the intermediate transfer belt of the present invention includes a surface-cured layer on a substrate and the surface-cured layer is structured by a reaction product of at least an active energy ray curable monomer, reactive metal oxide particles, and a graft copolymer of a polymerizable fluorine resin and a polymerizable siloxane.

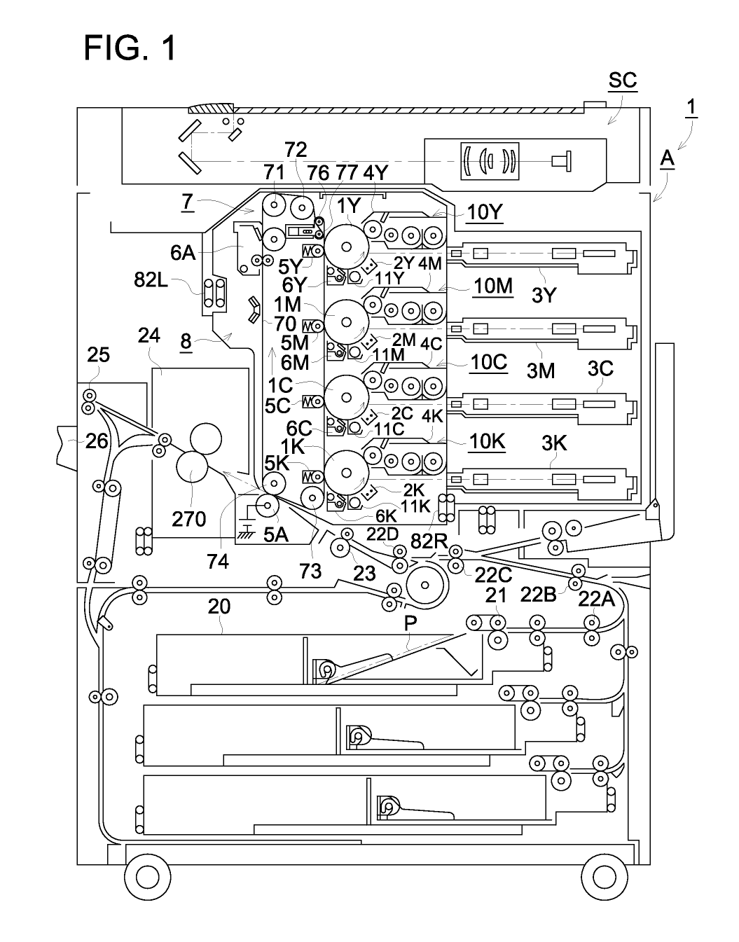

Next, embodiments of the present invention will be explained with reference to FIGS. 1 through 4. However, the present invention is not limited to these embodiments.

FIG. 1 is an outline cross sectional structural diagram showing an example of an image forming apparatus of an electro-photographing type which employs an intermediate transfer belt as an intermediate transfer member. In this regard, FIG. 1 shows one example of a full color image forming apparatus.

In FIG. 1, numeral 1 represents a full color image forming apparatus. The full color image forming apparatus 1 includes plural sets of image forming sections 10Y, 10M, 10C and 10K, endless belt type intermediate transfer unit 7 representing a transfer section, endless belt type sheet feeding conveyance means 21 that conveys recording member P and heat roll type fixing device 24. On the upper part of main body A of the image forming apparatus, there is arranged document image reading device SC.

Image forming sections 10Y that forms an image of a yellow color as one of a toner image in a different color formed on each photoreceptor has therein drum-shaped photoreceptor 1Y as a first photoreceptor, charging means 2Y arranged around photoreceptor 1Y, exposure means 3Y, developing means 4Y, primary transfer roller 5Y as a primary transfer means and cleaning means 6Y.

Image forming sections 10M that forms an image of a magenta color as one of a toner image in another different color has therein drum-shaped photoreceptor 1M as a first photoreceptor, charging means 2M arranged around the photoreceptor 1M, exposure means 3M, developing means 4M, primary transfer roller 5M as a primary transfer means and cleaning means 6M.

Image forming section 10C that forms an image of a cyan color as one of a toner image in still another different color has therein drum-shaped photoreceptor 1C as a first photoreceptor, charging means 2C arranged around photoreceptor 1C, exposure means 3C, developing means 4C, primary transfer roller 5C as a primary transfer means and cleaning means 6C.

Further, image forming section 10K that forms an image of a black color as one of a toner image in still more another different color has therein drum-shaped photoreceptor 1K as a first photoreceptor, charging means 2K arranged around photoreceptor 1K, exposure means 3K, developing means 4K, primary transfer roller 5K as a primary transfer means and cleaning means 6K.

Endless belt type intermediate transfer unit 7 has endless belt type intermediate transfer member 70 as a second photoreceptor in the form of an intermediate transfer endless belt, which is rolled by plural rollers, and supported rotatably.

Images each being in a different color formed respectively by image forming sections 10Y, 10M, 10C and 10K are transferred sequentially onto rotating endless belt type intermediate transfer member 70 respectively by primary transfer rollers 5Y, 5M, 5C and 5K, whereby a combined color image is formed. Recording member P such as a sheet as a transfer material loaded in sheet-feeding cassette 20 is fed by sheet-feeding conveyance means 21, to be conveyed to secondary transfer roller 5A as a secondary transfer means through plural intermediate rollers 22A, 22B, 22C and 22D as well as registration roller 23, thus, the color images are transferred all together onto the recording member P.

The recording member P onto which the color image has been transferred is fixed by heat roll type fixing device 24, and is interposed by sheet-ejection roller 25 to be placed on sheet-ejection tray 26 located outside the apparatus.

On the other hand, after the color image is transferred by second transfer roller 5A onto recording member P, toner remaining on endless belt type intermediate transfer member 70 is removed from endless belt type intermediate transfer member 70 via curvature separation of recording member P, by cleaning means 6A.

During image forming processing, primary transfer roller 5K is constantly in pressure contact with photoreceptor 1K. Other primary transfer rollers 5Y, 5M and 5C are in pressure contact respectively with corresponding to photoreceptors 1Y, 1M and 1C only in the course of color image forming.

Second transfer roller 5A comes in contact with endless belt type intermediate transfer member 70 only when recording member P passes through second transfer roller 5A and the secondary transfer is carried out.

Enclosure 8 is designed to be drawn out of apparatus main body A through supporting rails 82L and 82R. Enclosure 8 has therein image forming sections 10Y, 10M, 10C and 10K, as well as endless belt type intermediate transfer unit 7.

Image forming sections 10Y, 10M, 10C and 10K are arranged in tandem in the vertical direction. On the left side of photoreceptors 1Y, 1M, 1C and 1K, there is arranged endless belt type intermediate transfer unit 7. Endless belt type intermediate transfer unit 7 possesses endless belt type intermediate transfer member 70 rotatable via rotation of rollers 71, 72, 73, 74 and 76, primary transfer rollers 5Y, 5M, 5C and 5K, and cleaning means 6A.

When enclosure 8 is drawn out, image forming sections 10Y, 10M, 10C and 10K as well as endless belt type intermediate transfer unit 7 are drawn out all together from main body A.

In this way, a toner image is formed on each of photoreceptors 1Y, 1M, 1C and 1K through charging, exposure and developing, then, toner images having respective colors are superimposed each other on endless belt type intermediate transfer member 70, and they are transferred all together onto recording member P, to be fixed by heat roll type fixing device 24 through application of pressure and heating.

Each of photoreceptors 1Y, 1M, 1C and 1K, after the toner image thereon has been transferred onto recording member P, is cleaned by cleaning means 6Y, 6M, 6C, and 6K, which are provided to respective photoreceptors 1Y, 1M, 1C and 1K, so as to remove remaining toner on the photoreceptor during transferring, and then, the photoreceptors enter the above-described cycle of charging, exposure and developing so that succeeding image forming may be carried out.

In the above-mentioned color image forming apparatus, an elastic blade is used as a cleaning member of a cleaning means 6A to clean an intermediate transfer member. Further, photoreceptors 1Y, 1M, 1C and 1K is provided with respective means (11Y, 11M, 11, 11C, and 11K) for coating fatty acid metal salt. As the coating fatty acid metal salt, the same compound as that used to toner may be employed.

A the present invention relates to an intermediate transfer belt for use in an image forming apparatus of an electro-photographing system shown in FIG. 1 as one example, and to a method for manufacturing this intermediate transfer belt.

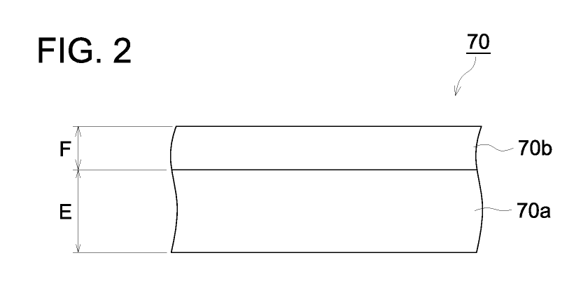

FIG. 2 is a partially enlarged outline cross sectional view of the intermediate transfer belt of the intermediate transfer member shown in FIG. 1.

In the drawing, numeral 70 represents an intermediate transfer belt. The intermediate transfer belt has the structure that a surface layer 70b is provided on an endless belt-like substrate 70a.

The endless belt-like substrate 70a has a hardness of 20 MPa to 200 MPa desirably in consideration of mechanical strength, image quality, manufacturing cost and the like.

Further, the endless belt-like substrate 70a has a thickness E of 50 μm to 250 μm desirably in consideration of mechanical strength, image quality, manufacturing cost and the like.

Furthermore, the endless belt-like substrate 70a has a hardness of 200 MPa to 1200 MPa in universal hardness (HU) (DIN 50359) in consideration of scraped flaw, abrasion, durability, a transfer rate, filming, image quality, and the like.

The hardness is a value measured under the conditions by use of a super micro hardness tester “H-100V (manufactured by Fischer Instrument Inc.)”.

Measuring conditions

Measuring device: A super micro hardness tester

“H-100V (manufactured by Fischer Instrument Inc.)”

Measuring indenter: Vickers indenter (a=136°)

Measuring environment: 20° C. and 60% RH

Maximum test load: 2 mN

Loading rate: 2 mN/10 sec

Creep time under the maximum load: 5 sec

Unloading rate: 2 mN/10 sec

The hardness of the surface layer 70b is measured by a different method from that of the endless belt-like substrate 70a. That is, the hardness of the surface layer 70b is measured in such a way that the surface layer 70b is coated so as to make a thickness to become 2 μm on an aluminum plate with a thickness of 1 mm, and the surface layer 70b is cured, then hardness is measured randomly at 10 to 30 points on the cured surface layer 70b. On the other hand, the endless belt-like substrate 70a is mounted on an aluminum plate with a thickness of 1 mm, and hardness is measured 5 points with an equal interval in the axial direction and 10 to 30 points in the circumferential direction. The average value of the measured values is made a universal hardness (HU).

With regard to unevenness of the universal hardness depending on locations in a circumferential direction on an intermediate transfer belt, a difference of the maximum value and the minimum value of the average values as the universal hardness (HU) in one sample is desirably 20% or less in consideration of transfer unevenness, image density unevenness, and image quality when a toner image on a photoreceptor is transferred onto the intermediate transfer belt. The unevenness of the universal hardness is determined by the following formula.

Unevenness of the universal hardness=(the maximum hardness in a peripheral direction at the same axis−the minimum hardness in a peripheral direction at the same axis)/the maximum hardness in a peripheral direction at the same axis

The surface layer 70b has a thickness F of 0.5 to 5 μm desirably in consideration of a transfer rate, durability, filming, and image quality.

The thickness of the surface layer is measured with a Fischer scope mms (registered trademark) manufactured by Fischer Instrumens Corporation.

Incidentally, in the case where the thickness of the surface layer is 1 μm or less, the hardness of such a thin film layer tends to be influenced by the physical properties of a substrate, and when an indenter is pressed in, there is fear that cracks may take place on the thin film layer. Accordingly, the hardness of a thin film layer with a thickness of 1 μm or less is preferably measured by a nano indentation method. In the measurement of hardness by the nano indentation method, a load of μN order is applied onto a thin film sample by use of a transducer and a diamond Berkovich indenter with a tip end shape of an equilateral triangle, and an amount of displacement is measured with an accuracy of nanometer. For this nano indentation method, a commercially-available “NANO Indenter XP/DCM”MTS NANO Instruments (manufactured by MTS Systems Corporation/MST NANO Instrument Corporation) may be employable. Further, the measurement of hardness by the nano indentation method is disclosed in SPA 200-212921.

The cured layer of the present invention has preferably a hardness of 0.5 GPa to 2.5 GPa in accordance with the nano indentation method on the following conditions.

Measuring conditions

Indenter: Cube corner tip (90°)

Maximum load: 20 μN

Loading rate: 20 μN/5 sec

Unloading rate: 20 μN/5 sec

The structure of the endless belt-like substrate 70a is not limited specifically, and may be composed on a single layer or two layers. FIG. 2 shows an example of the endless belt-like substrate 70a composed of a single layer.

The structure of the surface layer 70b is not limited specifically, and may be composed on a single layer or two layers. FIG. 2 shows an example of the surface layer 70b composed of a single layer.

The surface layer 70b has a friction coefficient of 0.25 or less desirably in consideration of filming resistance, transferability, and the like.

The friction coefficient is a value measured by a portable friction meter “Muse TIPE:94 i-II (manufactured by Shinto science incorporated company).”

Friction coefficient is measured at 10 to 30 points at random on the surface layer 70b, and an average value of these measurement values is made a friction coefficient (μ).

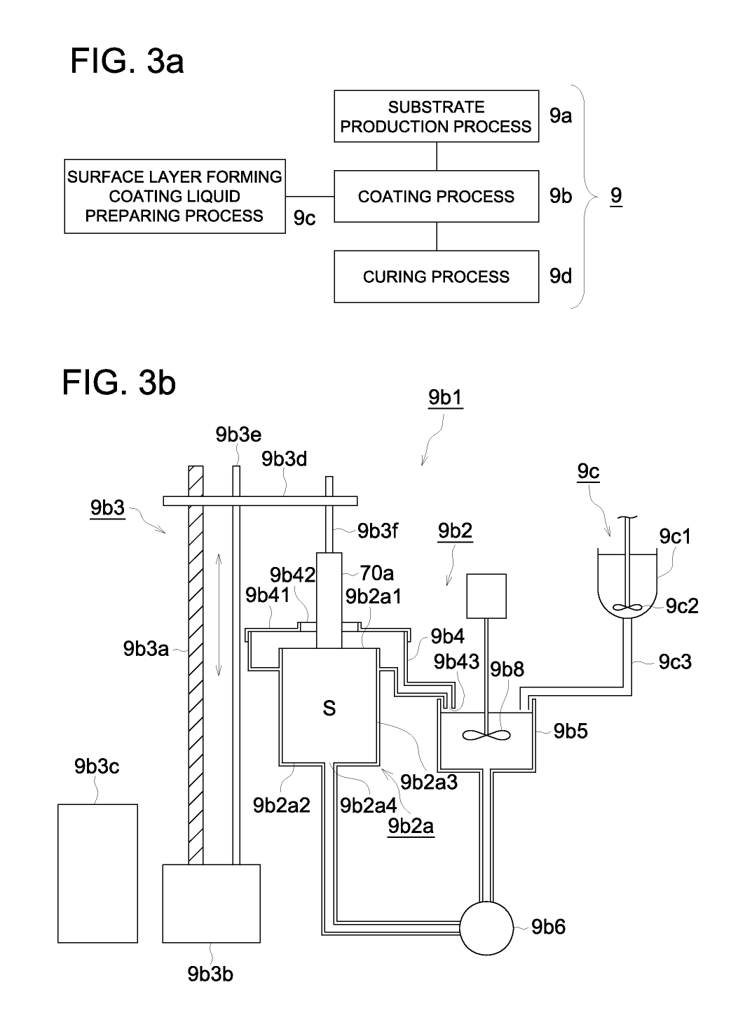

FIGS. 3a and 3b are outline diagrams of a manufacturing process which manufactures the intermediate transfer belt shown in FIG. 2. FIG. 3a is an outline flowchart to manufacture the intermediate transfer belt shown in FIG. 2, and FIG. 3b is an outline diagram sowing one example of a coating apparatus which is used in a coating process shown in FIG. 3a and coats a coating liquid to form a surface layer onto the surface of a substrate used by the application process shown in FIG. 3 (a).

The manufacturing process 9 of the intermediate transfer belt which has a surface layer of the present invention, includes a substrate manufacturing process 9a which manufactures an endless belt-like substrate as a substrate, a coating process 9b which coats a coating liquid for forming a surface layer onto the surface of the manufactured endless belt-like substrate, a preparation process 9c to prepare the coating liquid for forming the surface layer, and a cure treatment process 9d which cures the coating layer formed by the coating process 9b.

In the substrate manufacturing process 9a, the endless belt-like substrate 70a shown in FIG. 2 is manufactured by conventionally well-known general production methods. For example, a resin used as material is melted by an extruder, the melted resin is molded in the form of a cylinder by inflation molding with an annular die, and then the resin cylinder is cut out into a ring, whereby an annular endless belt-like substrate can be manufactured. Further, in well-known general production methods, a polyamide acid solution is molded in the form of a ring by an appropriate method such as a method of coating the solution on an outer peripheral surface of a cylindrical mold; a method of coating the solution on an inner surface; a method of centrifuge the solution; or a method of filling the solution a injection mold, and subsequently, the ring-shaped layer is dried so as to be molded in the form of a belt, the molded belt is subjected to heat treatment so as to convert the polyamide acid into imide, whereby an annular endless belt-like substrate can be manufactured (JPA 61-95361, 64-22514, and 3-180309).

In the above manufacture of an endless belt, appropriate additional processing, such as mold-release processing, degassing processing can be conducted. In the endless belt-like substrate 70a, a conducting agent is dispersed in a resin substrate so that the endless belt-like substrate 70a has preferably conductivity (refer to FIG. 2).

In the preparation process 9c for preparing a coating liquid for forming a surface layer, employed are a preparing container 9c1 for preparing a coating liquid for forming a surface layer, a stirrer 9c2, and a liquid feeding tube 9c3 that feeds the prepared coating liquid for forming a surface layer to a coating liquid supply tank 9b5 of a dip-coating apparatus 9b1 are being used for the coating-liquid.

The surface layer-forming coating liquid prepared by the surface layer-forming coating liquid preparation process 9c includes an active energy ray curable monomer, reactive metal oxide particles, and a fluorine resin/siloxane graft type resin having radical polymerizable unsaturated bonding parts. The surface layer-forming coating liquid will be explained in detail later.

Symbol 9b1 represents the dip-coating apparatus used in the coating process 9b. The dip-coating apparatus 9b1 includes a coating section 9b2 and a supply section 9b3 of a substrate for an intermediate transfer belt. The coating section 9b2 includes a coating tank 9b2a; an overflow-liquid receiving vessel 9b4 which is arranged at an upper portion of the coating tank 9b2a in order to receive a coating liquid which overflows from an opening portion 9b2a1 of the coating tank 9b2a; a coating liquid feeding tank 9b5, and a liquid feeding pump 9b6.

The coating tank 9b2a includes a bottom portion 9b2a2 and a side wall 9b2a3 which is made to stand up from the peripheral surface of the bottom portion 9b2a2, the upper portion is structured to be the opening portion 9b2a1. Symbol 9b2a4 represents a coating liquid feed port of a surface layer-forming coating liquid S fed from the liquid feeding pump 9b6 provided to the bottom portion 9b2a2 of the coating tank 9b2a. The coating tank 9b2a is shaped in the form of a cylinder in which the diameter of the opening portion 9b2a1 is the same size as that of the bottom portion 9b2a2.

Symbol 9b41 represents a lid of the overflow-liquid receiving vessel 9b4, and the lid 9b41 has an aperture 9b42 at its center.

Symbol 9b43 represents a coating liquid return port through which the coating liquid in the overflow-liquid receiving vessel 9b4 returns to the coating liquid feeding tank 9b5. Character S represents a coating liquid for forming a surface layer. Symbol 9b8 represents stirring blades provided in the coating liquid feeding tank 9b5.

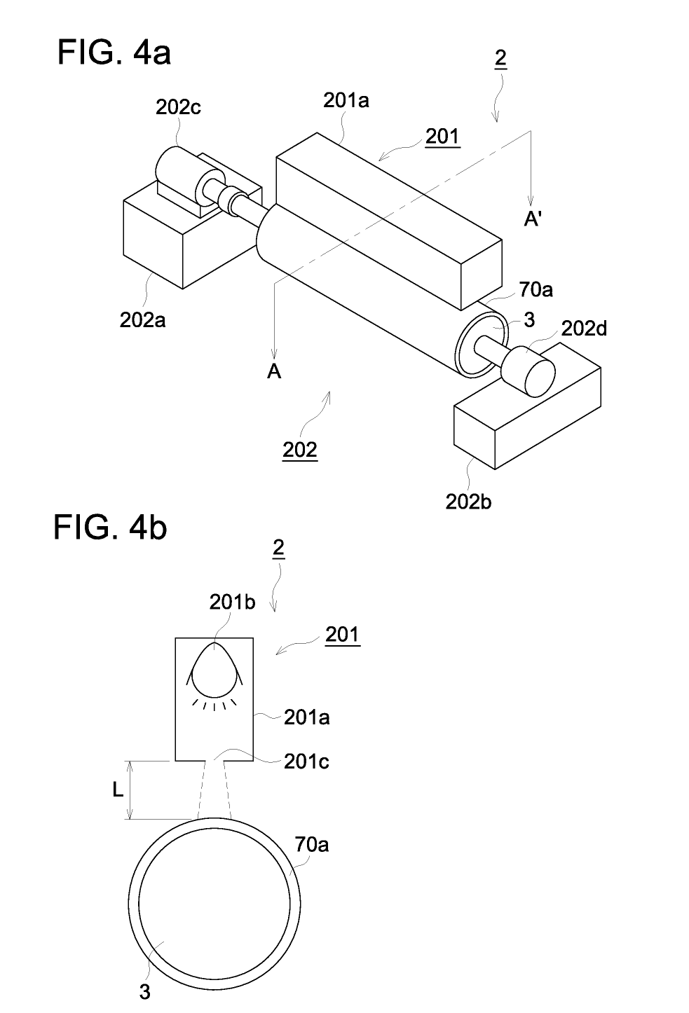

The supply section 9b3 includes ball screw 9b3a, a driving section 9b3b which rotates the ball screw 9b3a, a control section 9b3c which controls the rotational speed of ball screw 9b3a, an up-and-down member 9b3d connected via screw with the ball screw 9b3a, and a guide member 9b3e which moves the up-and-down member 9b3d upward or downward (arrowed mark direction in FIG. 2b) with the rotation of the ball screw 9b3a. Symbol 9b3f represents a holding member which is attached to the up-and-down member 9b3d and is adapted to hold an endless belt-like substrate of the intermediate belt. In this connection, the endless belt-like substrate 70a is made in the state that endless belt-like substrate 70a is held on the surface of a cylindrical or columnar component 3 (refer to FIG. 4) the of which is made to correspond to the diameter of the endless belt-like substrate. The holding member 9b3f is attached to the up-and-down member 9b3d in such a way that the held endless belt-like substrate 70a of the intermediate belt is located at the center of the coating tank 9b2a.

With the rotation of the ball screw 9b3a, the up-and-down member 9b3d is moved upward or downward so that the endless belt-like substrate 70a of the intermediate belt held by the holding member 9b3f attached to the up-and-down member 9b3d is immersed in the coating liquid S for forming a surface layer in the coating tank 9b2a, and then is lifted up from the coating tank 9b2a, whereby the coating liquid is coated on the surface of the endless belt-like substrate 70a of the intermediate belt.

A speed at which the endless belt-like substrate 70a is lifted up is needed to be changed appropriately depending on the viscosity of the used coating liquid for forming a surface layer. For example, in the case where the viscosity of the coating is 10 mPa·s to 200 mPa·s, the speed is 0.5 mm/see to 15 mm/sec desirably in consideration of coating uniformity, coating-layer thickness, drying ability, and the like. After the surface of the endless belt-like substrate 70a of an intermediate belt is coated with the coating liquid S for forming a surface layer by use of the dip-coating apparatus shown in FIG. 3, a coating layer for forming a surface layer is irradiated with active energy rays in the cure treatment process 95 so that the coating layer is cured, whereby a cured surface layer can be formed. Before curing, the coating layer may be heated and dried. A drying temperature may be 60° C. to 150° C. preferably.

In the above embodiment, the dip-coating method is explained. However, a method of coating a coating liquid S for forming a surface layer onto the surface of the endless belt-like substrate 70a of an intermediate belt is not limited specifically to the dip-coating method, and well-known coating method can be employed. For example, an annular coating method using an annular coating tank, a spray coating method, a coating method employing an ultrasonic atomizer may be employed.

In the cure treatment process 9d, a cure processing device 2 (refer to FIG. 4) is employed. That is, in the cure treatment process 9d, a cure treatment is conducted such that a coating layer for forming a surface layer is irradiated with active energy rays, thereby forming a cured surface layer 70b shown in FIG. 2.

FIG. 4 is an outline diagram showing an example of the cure processing device for a surface layer (protective layer) which is used in the cure treatment process shown in FIG. 3. FIG. 4a is an outline perspective view showing an example of a cure processing device for a surface layer (protective layer) which is used in the cure treatment process shown in FIG. 3. FIG. 4b is an outline enlarged sectional view in alignment with A-A′ shown in FIG. 4 (a).

In FIG. 4, numeral 2 represents a cure processing device for the surface layer of the endless belt-like substrate 70a. The cure processing device includes an activity energy ray irradiating device 201 and a supporting structure 202 of a cylindrical or columnar member 3 to hold an endless belt substrate 70a (refer to FIG. 2) which has a coating layer of a surface layer formed on its surface. The activity energy ray irradiating device 201 is positioned opposite to the cylindrical or columnar member 3 and is adapted to irradiate activity energy rays onto a coating layer for forming a surface layer on the cylindrical or columnar member 3. A curing treatment is conducted so as to irradiate activity energy rays onto a coating layer for forming a surface layer, whereby a surface layer 70b shown in FIG. 2 is formed.

The activity energy ray irradiating device 201 includes a case body 201a, an activity energy ray source 201b installed in the case body 201a, and an energy control device (not-shown) of the activity

energy ray source 201b. The activity energy ray irradiating device 201 is arranged and fixed on a frame (not-shown) of the cure processing device 2. Symbol 201c represents an activity energy ray irradiating port provided to the bottom portion of the case body 201a (the surface opposite to the surface of the endless belt-like substrate 70a).

Symbol L represents a distance between the irradiating port 201c and the surface of a coating layer for forming a surface layer on the endless belt-like substrate 70a. The distance L can be appropriately set depending on the strength of activity energy rays, the kind of a coating layer for forming a surface layer and the like.

The supporting device 202 includes a first holding stand 202a, a second holding stand 202b, and a driving motor 202c.

The driving motor 202c is arranged on the first holding stand 202a, and the cylindrical or columnar member 3 is connected to a rotation shaft of the driving motor 202c via an attachment shaft of the cylindrical or columnar member 3 and a connecting member.

On the second holding stand 202b, mounted is a shaft receiving section to receive another attachment shaft of the cylindrical or columnar member 3. With this arrangement, the cylindrical or columnar member 3 is supported while being rotated by driving motor 202c when being irradiated with activity energy rays by the activity energy ray irradiating device 201.

The rotational speed (circumferential speed) of the cylindrical or columnar member 3 when being irradiated with activity energy rays is 10 mm/s to 300 mm/s desirably in consideration of cure unevenness, hardness, curing time, and the like.

This embodiment shows the case where the activity energy ray irradiating device 201 is fixed and the cylindrical or columnar member 3 is rotated while being irradiated with activity energy rays.

However, it may be structured that the cylindrical or columnar member 3 is fixed and the activity energy ray irradiating device 201 may be moved along the circumference of the cylindrical or columnar member 3. Further, this embodiment shows the case where the cylindrical or columnar member 3 is placed horizontally. However, it may be possible that the cylindrical or columnar member 3 is placed vertically.

There is no restriction to the type of the energy source for applying the actinic energy radiation used in the present invention, if it activates the compound by the ultraviolet ray, electron beam or γ ray. The ultraviolet ray and electron beam are preferably used. The ultraviolet ray is particularly preferred since handling is easy and a high level of energy can be easily obtained. Any light source capable of generating the ultraviolet ray can be used as the light source of the ultraviolet ray for causing photo-polymerization of ultraviolet ray reactive compound. For example, it is possible to use the low voltage mercury lamp, intermediate voltage mercury lamp, high voltage mercury lamp, extra-high voltage mercury lamp, carbon are light, metal halide lamp and xenon lamp. Further, the ArF excimer laser, KrF excimer laser, excimer lamp and synchrotron radiation can also be used. In order to irradiate with activity energy rays in the form of a spot, it is desirable to use ultraviolet laser.

Further, electron beams can be used similarly Examples of electron beams include electron rays with energy of 50 keV to 1000 keV, preferably 100 keV to 300 keV emitted from various electron beam accelerators, such as Cockcroft-Walton type, Van de Graaff type, resonance transformer type, insulation core transformer type, straight line type, Dynamitron type, and high frequency type.

The irradiating condition may differ depending on respective light sources. The amount of irradiation light is desirably 100 mJ/cm² or more, more desirably 120 mJ/cm² to 200 mJ/cm², still more desirably 150 mJ/cm² to 180 mJ/cm² in consideration of curing unevenness, hardness, curing time, curing rate, and the like. The amount of irradiation light is a value measured by UIT250 (manufactured by USHIO, INC.).

The irradiation time of activity energy rays is preferably from 0.5 seconds to 5 minutes and more preferably from 3 seconds to 2 minutes from the viewpoints of the curing efficiency of activity energy ray curable resins, working efficiency, and the like.

In the present invention, with regard to atmosphere at the time of irradiation of activity energy rays, it is possible to cure resin under air atmosphere without problems. However, in consideration of curing unevenness, curing time, and the like, an oxygen concentration in the atmosphere 5% or less, and preferably 1% or less. In order to attain such an atmosphere, it is effective to introduce nitrogen gas.

The oxygen concentration is a value measure by an oxygen analyzer OX100 (manufactured by YOKOGAWA ELECTRIC CORP.) for atmosphere gas administration.

Moreover, in the present invention, in order to advance the cure reaction of activity energy rays efficiently, the coating layer for forming a surface layer may be heated. Although the heat method is no limited in particular, for example, blowing of heat air may be employed. Although the heating temperature is not specified generally depending on the kind of activity energy ray curable resins, it may be preferably within a temperature range which does not influence a coating layer for forming a surface layer, desirably 40° C. to 100° C., more desirably 40° C. to 80° C., and still more desirably 40° C. to 60° C.

Next, a coating liquid for forming a surface layer will be explained. The surface layer-forming coating liquid used in the present invention has a composition including an active energy ray curable monomer, reactive metal oxide particles, and a fluorine resin/siloxane graft type resin having radical polymerizable unsaturated bonding parts.

In consideration of a transfer rate, flaw resistance, wear resistance, mold-release property, filming resistance, and the like, the coating liquid for forming a surface layer is composed of 12.5 parts by volume to 400 parts by volume of the reactive metal oxide particles and 25 parts by volume to 300 parts by volume of the fluorine resin/siloxane graft type resin to 100 parts by volume of an activity energy ray curable monomer, and an amount of the reactive metal oxide particles is 10 parts by volume or more and 50 parts by volume or less to the total amount of the activity energy ray curable monomer, the fluorine resin/siloxane graft type resin and the reactive metal oxide particles.

### [Activity Energy Ray Curable Monomer]

The activity energy ray curable monomer is a monomer capable of reacting with a radical polymerizable functional group of metal oxide particles, and various monomers which have a carbon-carbon double bond can be employed.

As the abovementioned activity energy ray curable monomer, preferable is a radical polymerizable monomer which polymerizes (harden, cure) upon irradiation with actinic-rays such as ultraviolet rays, electron beams, etc. so as to become resin, such as polystyrene, polyacrylate, etc., generally used as binder resin of a photoreceptor. In radical polymerizable monomers, especially, preferable examples include a styrene type monomer, an acrylic type monomer, a methacrylic type monomer, a vinyltoluene type monomer, a vinyl acetate type monomer, and a N-vinyl-pyrrolidone type monomer. Among the above monomers, especially, an acrylic compound having an acryloyl group or a methacryloyl group is desirable, because it can be cured with a small quantity of light or for a short time.

In the present invention, the radical polymerizable monomer may be used solely or in combination.

Hereafter, among the radical polymerizable monomers, an example of acrylic monomer is shown. An acrylic monomer is a compound which has an acryloyl group (CH₂═CHCO—) or a methacryloyl group (CH2=CCH3CO—). Hereafter, an Ac group number (the number of acryloyl groups) represents the number of acryloyl groups or methacryloyl groups.

| No. | | Ac Number |
|---|---|---|
| (1) | 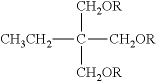 | 3 |
| (2) | 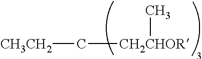 | 3 |
| (3) | 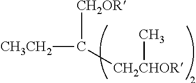 | 3 |
| (4) | 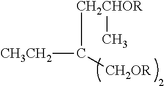 | 3 |
| (5) | 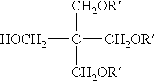 | 3 |
| (6) | 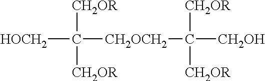 | 4 |
| (7) | 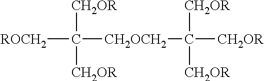 | 6 |
| (8) | 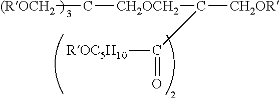 | 6 |
| (9) | 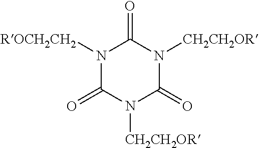 | 3 |
| (10) | CH₃CH₂C CH₂OC₃H₆OR)₃ | 3 |
| (11) | 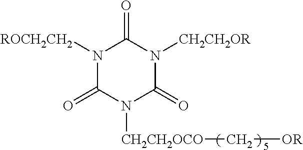 | 3 |
| (12) | 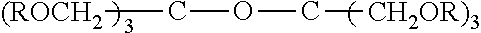 | 6 |
| (13) | 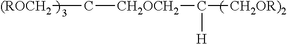 | 5 |
| (14) | 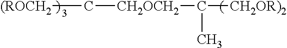 | 5 |
| (15) | 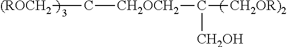 | 5 |
| (16) | 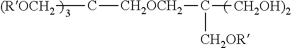 | 4 |
| (17) | 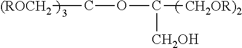 | 5 |
| (18) | 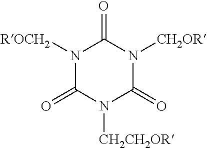 | 3 |
| (19) | CH₃CH₂—C CH₂CH₂OR)₃ | 3 |
| (20) | 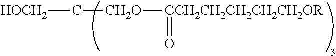 | 3 |
| (21) | 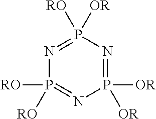 | 6 |
| (22) | 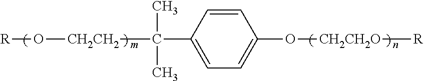 | 2 |
| (23) | 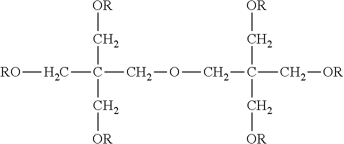 | 6 |
| (24) | 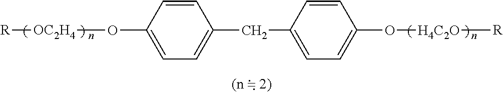 | 2 |
| (25) | 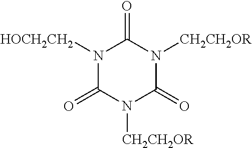 | 2 |
| (26) | 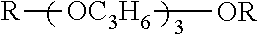 | 2 |
| (27) | 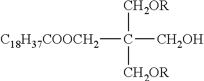 | 2 |
| (28) | 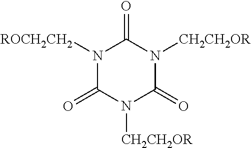 | 3 |
| (29) | 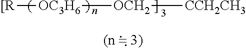 | 3 |
| (30) | 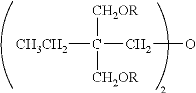 | 4 |
| (31) | 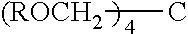 | 4 |
| 32 | RO—C₆H₁₂—OR | 2 |
| 33 | 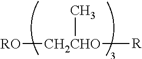 | 2 |
| 34 | 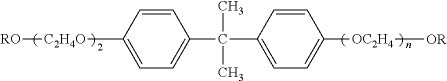 | 2 |
| 35 | 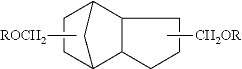 | 2 |
| 36 | 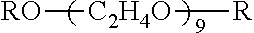 | 2 |
| 37 | 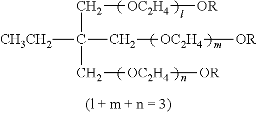 | 3 |
| 38 | 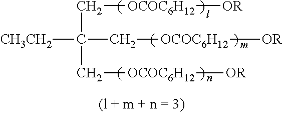 | 3 |
| 39 | 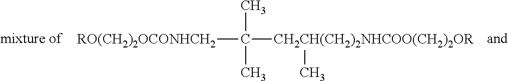 | 2 |
| | 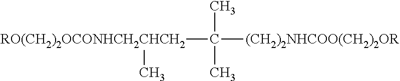 | |
| 40 | (ROCH₂)₃CCH₂OCONH(CH₂)₆NHCOOCH₂C(CH₂OR)₃ | 2 |
| 41 | 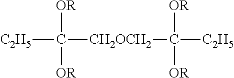 | 4 |
| 42 | 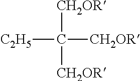 | 3 |
| 43 | 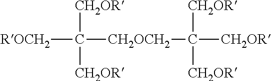 | 6 |
| 44 | 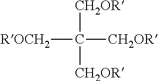 | 4 |

In the above formulas, R and R′ is shown below.

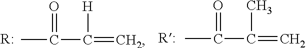

Further, specific examples of a desirable oxetane compound are shown below.

| | |
|---|---|
| 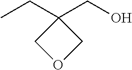 | 45 |
| 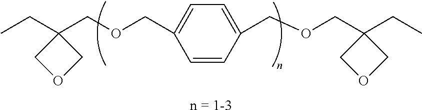 | 46 |
| 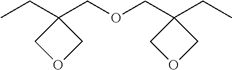 | 47 |
| 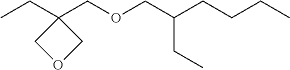 | 48 |
| 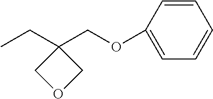 | 49 |
| 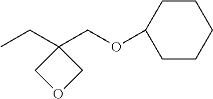 | 50 |
| 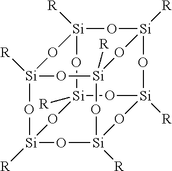 | 51 |
| 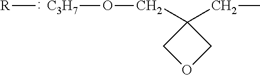 | |
| 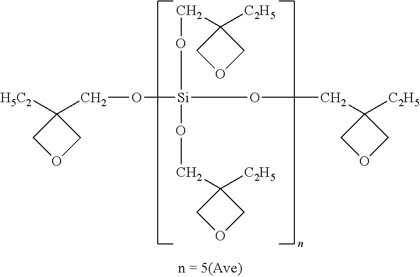 | 52 |
| 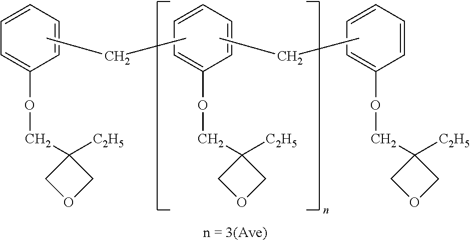 | 53 |
| 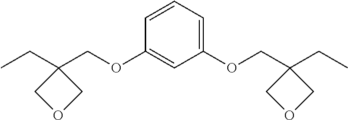 | 54 |
| 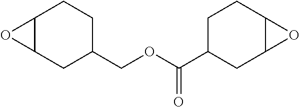 | 55 |
| 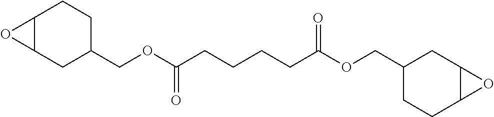 | 56 |
| 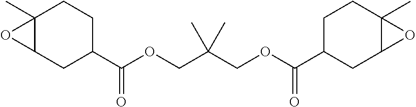 | 57 |
| 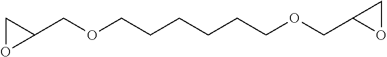 | 58 |
| 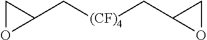 | 59 |
| 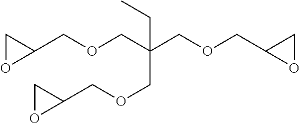 | 60 |
| 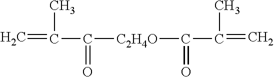 | 61 |

In the present invention, the functional group of an acrylic monomer is desirably 2 or more, and particularly desirably 4 or more. Moreover, in the above-mentioned acrylic monomer, a preferable monomer has a ratio (Ac/M) of 0.005 or more, wherein Ac is the number of acryloyl groups, or methacryloyl groups, and M is the molecular weight of a compound having an acryloyl group or a methacryloyl group. The structure employing such a compound raises a polymerization reaction rate and enlarges Ac/M so that a surface layer of an intermediate transfer belt can be formed with a high film density.

Examples of compounds with Ac/M larger than 0.005, include exemplary compound Nos. 1 to 19, 21, 23, 26, 28, 30, 31 to 33, 35, 37, and 40 to 44.

Furthermore, the preferable acrylic monomers have a reactive acryloyl group and Ac/M satisfying a range of larger than 0.005 and smaller than 0.012.

The employment of such a preferable acrylic monomer makes crosslinking density become high and improves the wear resistance of the surface layer of an intermediate transfer belt.

In the present invention, two or more kinds of curable compounds different in functional group density may be used.

### [Reactive Metal Oxide Particles]

The reactive metal oxide particles used in the present invention means metal oxide particle subjected to surface treatment with a compound having a radical polymerizable functional group, and can be obtain by the surface treatment of the metal oxide particles with the compound having a radical polymerizable functional group.

### [Metal Oxide Particles]

Examples of the metal oxide particle used in the present invention include metal oxide particles including transition metals, such as silica (silicon oxide), magnesium oxide, zinc oxide, lead oxide, aluminium oxide, tantalum oxide, indium oxide, bismuth oxide, yttrium oxide, cobalt oxide, copper oxide, manganese oxide, selenium dioxide, iron oxide, zirconium oxide, germanium oxide, tin oxide, titanium oxide, niobium oxide, molybdenum oxide, and vanadium oxide. Among them, particles such as titanium oxide, alumina, zinc oxide, and tin oxide, are desirable, and particularly alumina and tin oxide are desirable.

These metal oxide particles are produced by general manufacturing methods, such as a gas phase method, a chlorine method, a sulfuric acid method, a plasma method, and an electrolytic method.

Their number average primary particle size is desirably in a range of 1 to 300 nm, specifically desirably in a range of 3 to 100 nm. If the particle size is too small than the above range, a wear-resistant improving performance is not sufficient. On the contrary, if the particle size is too large, particles may scatter image light at the time of writing an image, or obstruct light curing at the time of forming a surface layer, which results in that there is also a possibility that the large particle size may cause a bad influence to wear resistance.

The above number average primary particle size of inorganic particles can be obtained in such a way that an enlarged photograph of particles with a magnification of 10000 times is taken by a scanning type electron microscope, photographed images of 300 particles (except coagulated particles) are sampled randomly from the enlarged photograph by a scanner, and then the number average primary particle size is calculated from the photographed images by the use of an automatic image processing and analyzing apparatus LUZEX AP (manufactured by Nireco Corporation) with a software version of Ver.1.32.

The compound which has a radical polymerizable functional group used for the surface treatment for metal oxide particles will be explained.

Preferable examples of the compound which has a radical polymerizable functional group used for the surface treatment for metal oxide particles, include a compound which includes a functional group having a carbon-carbon double bond and a polar group, such as an alkoxy group, capable of coupling with a hydroxyl group on the surface of metal oxide particles in the same molecule.

Preferable examples of the compound which has a radical polymerizable functional group, include a compound having a functional group which polymerizes (cures) upon irradiation of activity energy rays, such as ultraviolet rays, electron beams, and the like, and becomes resins, such as polystyrene and polyacrylate. Among them, a silane compound having a reactive acryloyl group or a methacryloyl group is particularly desirable, because it can cure with a small amount of light or in a short time.

The metal oxide particle subjected to surface treatment with a compound having a radical polymerizable functional group used in the present invention can be produced such that, for example, metal oxide particles are reacted with a compound represented by the following formula (A).

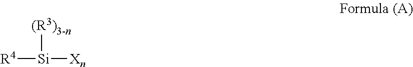

wherein R³ represents a hydrogen atom, an alkyl group having 1 to 10 carbon atoms and an aralkyl group having 1 to 10 carbon atoms, R⁴ represents an organic group having a reactive double bond, X represents a halogen atom, an alcoxy group, an acyloxy group, an aminoxy group and a phenoxy group, and n represents an integer of 1 to 3.

Hereafter, examples of compounds represented by the above general formula (A) are listed.
S-1 CH₂═CHSi(CH₃)(OCH₃)₂
S-2 CH₂═CHSi(OCH₃)₃
S-3 CH₂═CHSiCl₃
S-4 CH₂═CHCOO(CH₂)₂Si(CH₃)(OCH₃)₂
S-5 CH₂═CHCOO(CH₂)₂Si(OCH₃)₃
S-6 CH₂═CHCOO(CH₂)₃Si(CH₃)(OCH₃)₂
S-7 CH₂═CHCOO(CH₂)₃Si(OCH₃)₃
S-8 CH₂═CHCOO(CH₂)₂Si(CH₃)Cl₂
S-9 CH₂═CHCOO(CH₂)₂SiCl₃
S-10 CH₂═CHCOO(CH₂)₃Si(CH₃)Cl₂
S-11 CH₂—CHCOO(CH₂)₃SiCl₃
S-12 CH₂═C(CH₃)COO(CH₂)₂Si(CH₃)(OCH₃)₂
S-13 CH₂═C(CH₃)COO(CH₂)₂Si(OCH₃)₃
S-14 CH₂C(CH₃)COO(CH₂)₃Si(CH₃)(OCH₃)₂
S-15 CH₂═C(CH₃)COO(CH₂)₃Si(OCH₃)₃
S-16 CH₂═C(CH₃)COO(CH₂)₂Si(CH₃)Cl₂
S-17 CH₂═C(CH₃)COO(CH₂)₂SiCl₃
S-18 CH₂—C(CH₃)COO(CH₂)₃Si(CH₃)Cl₂
S-19 CH₂═C(CH₃)COO(CH₂)₃SiCl₃
S-20 CH₂═CHSi(C₂H₅)(OCH₃)₂
S-21 CH₂═C(CH₃)Si(OCH₃)₃
S-22 CH₂═C(CH₃)Si(OC₂H₅)₃
S-23 CH₂—CHSi(OCH₃)₃
S-24 CH₂C(CH₃)Si(CH₃)(OCH₃)₂
S-25 CH₂═CHSi(CH₃)Cl₂
S-26 CH₂═CHCOOSi(OCH₃)₃
S-27 CH₂═CHCOOSi(OC₂H₅)₃
S-28 CH₂═C(CH₃)COOSi(OCH₃)₃
S-29 CH₂═C(CH₃)COOSi(OC₂H₅)₃
S-30 CH₂═C(CH₃)COO(CH₂)₃Si(OC₂H₅)₃

Further, in addition to the compound represented by the above-mentioned general formula (A), silane compounds having the following reactive groups capable of performing a radical reaction may be employed.

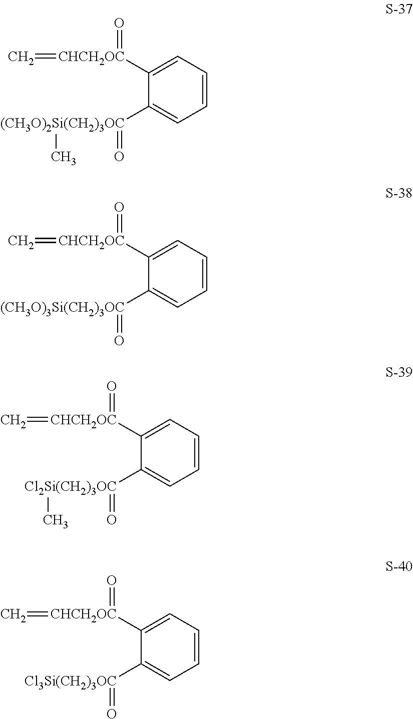

Moreover, examples of epoxy compounds which is out of compounds of the present invention and is used conventionally are shown below.

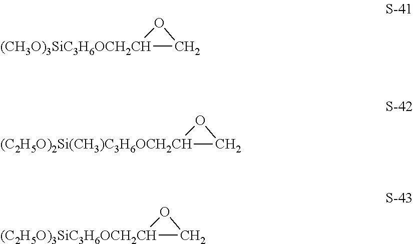

These silane compounds may be used solely or as a mixture of two or more kinds.

### [Method for Producing Reactive Metal Oxide Particles]

Next, a method for producing metal oxide particles (reactive metal oxide particles) subjected to surface treatment with a compound having a radical polymerizable functional group will be explained with an example of a case where a silane compound represented by the above mentioned formula (A) is used. At the time of operation of this surface treatment, it is desirable to process metal oxide particles with 0.1 to 200 parts by weight of silane compounds as a surface treating agent and 50 to 5000 parts by weight of a solvent to 100 parts by weight of the metal oxide particles by use of a wet type media dispersing type apparatus.

When a slurry (suspension liquid of solid particles) containing metal oxide particles and a silane compound is dispersed in a wet process, aggregate of the metal oxide particles are pulverized and simultaneously surface treatment for the metal oxide particles progresses. Thereafter, the solvent is removed, and the metal oxide particles are made in a form of powder, whereby it is possible to obtain the metal oxide particles having been subjected to the surface treatment with the uniform and fine silane compound.

A surface treatment amount of a compound having a radical polymerizable functional group (a covering amount of a compound having a radical polymerizable functional group) is preferably 0.1% by weight or more and 60% by weight or less, and specifically preferably 5% by weight or more and 40% by weight or less to the metal oxide particles.

This surface treatment amount of a compound having a radical polymerizable functional group is obtained in such a way that the metal oxide particles after the surface treatment are subjected to heat treatment at 550° C. for 3 hours, the residual components after the heat treatment are subjected to a quantitative analysis with fluorescence X rays, and the amount is obtained by molecular weight conversion from an amount of Si.

The wet type media dispersing type apparatus utilized as the surface treatment apparatus in the invention is an apparatus which has a pulverizing and dispersing process that fills up with beads as a dispersion media in a container and rotates agitation disks mounted perpendicularly on a rotating shaft at high speed so as to pulverize and disperse agglomerated particles of the metal oxide particles by agitating them. As its structure, if an apparatus can disperse the metal oxide particles sufficiently at the time of conducting a surface treatment for the metal oxide particles and can conduct the surface treatment, there is no problem. For example, various types, such as a vertical type or horizontal type, and a continuous type or batch type can be employable. Specifically, sand mill, Ultra visco mill, Pearl mill, Grain mill, DINO-mill, Agitator Mill, and Dynamic mill are employable. In these dispersing type apparatus, fine pulverizing and dispersing are conducted with impact crush, friction, shear force, and shear stress by the use of pulverizing media such as balls and beads.

As beads for use in the above sand grinder mill, balls made from raw materials, such as glass, alumina, zircon, zirconia, steel, flint stone, etc. can be used. However, beads made from zirconia or beads made from zircon may be especially desirable. A size of beads is usually about 1 to 2 mm, however, it is preferably 0.3 to 1.0 mm in the present invention.

As a material for a disk and an inner wall of container for use in a wet type media dispersing type apparatus, various materials such as stainless, nylon and ceramics are usable. Specifically, in the present invention, a disk and an inner wall of a container made of ceramics such as zirconia or silicon carbide are preferable.

By the abovementioned wet process, the metal oxide particles having been subjected to surface treatment with, for example, a silane compound, represented by a general formula (A), having a radical polymerizable functional group can be obtained.

[Fluorine Resin/Siloxane Graft Type Resin which has a Radical Polymerizable Unsaturated Bonding Part]

The radical polymerizable unsaturated bonding part means an unsaturated bond between a carbon atom and a carbon atom. The fluorine resin/siloxane graft type resin which has a radical polymerizable unsaturated bonding part means a copolymer having a repeating unit containing at least a fluorine atom and a repeating unit containing a siloxane structure. Examples of the copolymers include a graft copolymer obtained by copolymerization among 2% by weight to 70% by weight of an organic solvent soluble fluorine resin (A) (hereafter, also may be simply referred to as a radical polymerizable fluorine resin) having a radical polymerizable unsaturated bond part via urethane bonds, 2% by weight to 40% by weight of a single terminal radical polymerizable polysiloxane (B) represented by Formula (1) and/or Formula (2), and 15% by weight to 94% by weight of a radical polymerizable monomer (C) (hereafter, also referred to as a nonreactive radical polymerizable monomer) which conducts only polymerization reaction by double bonds with the radical polymerizable fluorine resin (A) via urethane bonds.

Although the molecular weight of the graft copolymer is not limited specifically, its weight average molecular weight is in a range of preferably about 5,000 to 2,000,000 (more preferably about 10,000 to 1,000,000) by GPC (gel permeation chromatography) with a polystyrene conversion, in consideration of film forming capability, weather resistance, crosslinking density, and the like.

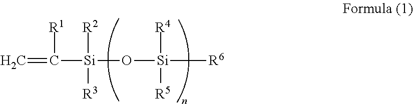

In Formula (1), R¹ is a hydrogen atom or a hydrocarbon group with 1 to 10 carbon atoms, R², R³, R⁴, R⁵, and R⁶ may be the same to or may be different from each other, and n is an integer of 2 or more.

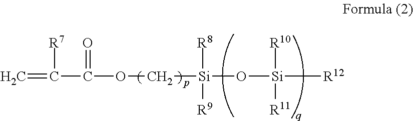

In Formula (2), R⁷ is a hydrogen atom or a hydrocarbon group with 1 to 10 carbon atoms, R⁸, R⁹, R¹⁰, R¹¹, and R¹² may be the same to or may be different from each other, p is an integer of 0 or 10, q is an integer of 2 or more.

An organic solvent soluble fluorine resin (A), used in the present invention, having a radical polymerizable unsaturated bond part via urethane bonds may obtained by reaction between an organic solvent soluble fluorine resin (A-1) having a hydroxyl group and a radical polymerizable monomer (A-2) having an isocyanate group.

The organic solvent soluble fluorine resin (A-1) having a hydroxyl group is not limited specifically as long as compounds contains a monomer portion containing a hydroxyl group and a polyfluoro paraffin portion as the structural components, and examples of the compounds include compounds containing a repeating unit represented by Formula (3), Formula (4) as the repeating unit.

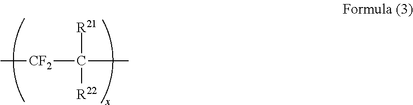

In Formula (3), R²¹ and R²² are independent for each repeating unit and may be the same to or may be different from each other, and are a hydrogen atom, a halogen atom (for example, a fluorine atom or a chlorine atom), an alkyl group with 1 to 10 carbon numbers (for example, a methyl group or an ethyl group), an aryl group with 6 to 8 carbon numbers (for example, a phenyl group), an alkyl group (for example, a trifluoromethyl group, a 2,2,2-trifluoroethyl group, and a trichloromethyl group) which has 1 to 10 carbon numbers and is substituted with one or more halogen atoms (for example, a fluorine atom or a chlorine atom), or an aryl group (for example, pentafluorophenyl group) which has 6 to 8 carbon numbers and is substituted with one or more halogen atoms (for example, a fluorine atom or a chlorine atom), x is an integer of 2 or more.

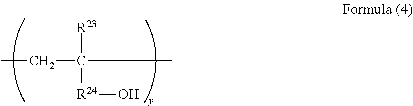

In Formula (4), R²³ is independent for each repeating unit, and is a hydrogen atom, a halogen atom (for example, a fluorine atom or a chlorine atom), an alkyl group with 1 to 10 carbon numbers (for example, a methyl group or an ethyl group), an aryl group with 6 to 8 carbon numbers (for example, a phenyl group), an alkyl group (for example, a trifluoromethyl group, a 2,2,2-trifluoroethyl group, and a trichloromethyl group) which has 1 to 10 carbon numbers and is substituted with one or more halogen atoms (for example, a fluorine atom or a chlorine atom), or an aryl group (for example, a pentafluorophenyl group) which has 6 to 8 carbon numbers and is substituted with one or more halogen atoms (for example, a fluorine atom or a chlorine atom), R²⁴ is independent for each repeating unit, and is a divalent group selected from an OR^{25a} group, a CH₂OR^{25b} group, and a COOR^{25c} group, the R^{25a}, R^{25b}, and R^{25c} are respectively a divalent group selected from an alkylene group with 1 to 10 carbon numbers (for example, a methylene group, ethylene, a trimethylene group, a tetramethylene group, or a hexamethylene group), a cyclo alkylene group with 6 to 10 carbon numbers (for example, a cyclohexylene group), an alkylidene group with 2 to 10 carbon numbers (for example, an isopropylidene group), and y is an integer of 2 or more.

Furthermore, the organic solvent soluble fluorine resin (A-1) having a hydroxyl group may contains, for example, a repeating unit represented by Formula (5) as the structure component depending on a case. The solubility of the fluorine resin (A-1) for the organic solvent can be improved by containing the repeating unit represented by Formula (5).

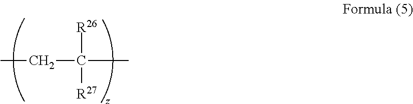

In Formula (5), R²⁶ is independent for each repeating unit, and is a hydrogen atom, a halogen atom (for example, a fluorine atom or a chlorine atom), an alkyl group with 1 to 10 carbon numbers (for example, a methyl group or an ethyl group), an aryl group with 6 to 10 carbon numbers (for example, a phenyl group), an alkyl group (for example, a trifluoromethyl group, a 2,2,2-trifluoroethyl group, and a trichloromethyl group) which has 1 to 10 carbon numbers and is substituted with one or more halogen atoms (for example, a fluorine atom or a chlorine atom), or an aryl group (for example, pentafluorophenyl group) which has 6 to 10 carbon numbers and is substituted with one or more halogen atoms (for example, a fluorine atom or a chlorine atom), R²⁷ is independent for each repeating unit, and is an OR^{28a} group or a OCOR^{2b} group, the R^{28a} and OR^{28b} are respectively a hydrogen atom, a halogen atom (for example, a fluorine atom or a chlorine atom), an alkyl group with 1 to 10 carbon numbers (for example, a methyl group or an ethyl group), an aryl group with 6 to 10 carbon numbers (for example, a phenyl group), a cycloalkyl group with 6 to 10 carbon numbers (for example, cyclohexyl group), an alkyl group (for example, a trifluoromethyl group, a 2,2,2-trifluoroethyl group, and a trichloromethyl group) which has 1 to 10 carbon numbers and is substituted with one or more halogen atoms (for example, a fluorine atom or a chlorine atom), or an aryl group (for example, a pentafluorophenyl group) which has 6 to 8 carbon numbers and is substituted with one or more halogen atoms (for example, a fluorine atom or a chlorine atom), and z is an integer of 2 or more.

The organic solvent soluble fluorine resin (A-1) may be used solely, or may be used as a mixture if two or more kinds.

The radical polymerizable monomer (A-2) having an isocyanate group is not limited specifically as long as monomers include an isocyanate group and a radical polymerizable portion, however, preferably employed are radical polymerizable monomers which include an isocyanate group and does not include the other functional groups (for example, a hydroxyl group and a polysiloxane chain). Preferable examples of the radical polymerizable monomer (A-2) having an isocyanate group include radical polymerizable monomers represented by Formula (6), Formula (7).

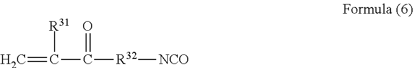

In Formula (6), R³¹ is a hydrogen atom, a hydrocarbon group with 1 to 10 carbon atoms, such as an alkyl group with 1 to 10 carbon atoms (for example, a methyl group, an ethyl group, a propyl group, a butyl group, a pentyl group or a hexyl group,), an aryl group with 6 to 10 carbon atoms (For example, a phenyl group), or a cycloalkyl group with 3 to 10 carbon atoms (For example, a cyclohexyl group 9; R³² is an oxygen atom, or a straight-lined or branched divalent hydrocarbon group with 1 to 10 carbon atoms, such as an alkylene group with 1 to 10 carbon atoms (for example, a methylene group, ethylene, a trimethylene group or a tetramethylene group), an alkylidene group with 2 to 10 carbon atoms (for example, an isopropylidene group), an arylene group with 6 to 10 carbon atoms (for example, a phenylene group, a tolylene group, or a xylylene group) or a cyclo alkylene group with 3 to carbon atoms (for example, cyclohexylene group).

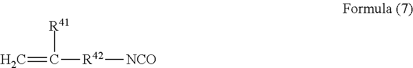

In Formula (7), R⁴¹ is a hydrogen atom, a hydrocarbon group with 1 to 10 carbon atoms, such as an alkyl group with 1 to 10 carbon atoms (for example, a methyl group, an ethyl group, a propyl group, a butyl group, a pentyl group or a hexyl group,), an aryl group with 6 to 10 carbon atoms (For example, a phenyl group), or a cycloalkyl group with 3 to 10 carbon atoms (For example, a cyclohexyl group 9; R⁴² is an oxygen atom, or a straight-lined or branched divalent hydrocarbon group with 1 to 10 carbon atoms, such as an alkylene group with 1 to 10 carbon atoms (for example, a methylene group, ethylene, a trimethylene group or a tetramethylene group), an alkylidene group with 2 to 10 carbon atoms (for example, an isopropylidene group), an arylene group with 6 to 10 carbon atoms (for example, a phenylene group, a tolylene group, or a xylylene group) or a cyclo alkylene group with 3 to carbon atoms (for example, cyclohexylene group).

The compounds described in Formulas (1) through (7) are the compounds described in JPA 2000-119354, and by use of these compounds, the fluorine resin/siloxane graft type resin which has a radical polymerizable unsaturated bonding part may produced by the method described in JPA 2000-119354.

Examples of the commercially-available fluorine fluorine resin/siloxane graft type resin include ZX series (manufactured by Fuji Chemical Industry, such as ZX-001 and ZX-007-C, ZX-017, ZX-022, and ZX-022-H, ZX-212, ZX-201, ZX-202, and ZX-214-A, ZX-101, and ZX-058-A.

A solvent may be contained in the above fluorine resin/siloxane graft type resin. However, hereafter, unless otherwise specified, “parts” and “%”, be related with nonvolatile components, and a solvent (volatile component) shall be removed.

Next, the substrate of the intermediate transfer belt of the present invention will be explained.

Examples of the materials of the substrate include resin materials, such as polycarbonate, polyphenylene sulfide (PPS), PVDF (polyvinylidene fluoride), polyimide, PEEK (polyether ether ketone), polyester, polyamide, polyphenylene sulfide, polycarbonate, polyvinylidene fluoride (PVDF), and polyfluoroethylene-ethylen copolymer (ETFE), and resin materials including the above resin materials as main materials. Further, materials in which the above resin materials and elastic materials are blended, may be also employed.

Examples of the elastic materials include polyurethane, chlorination polyisoprene, NBR, chloropyrene rubber, EPDM, hydrogenation polybutadiene, isobutylene-isoprene rubber, and silicone rubber. These materials may be used solely or may be used in combination of two kinds or more.

Among the above resin materials, polyimide resin may be desirable from the viewpoints of machine characteristics. Specific examples of the polyimide resin include imide resin materials of a polypyromellitic acid imide type, such as Kapton HA of DuPont, Inc.; imide resin materials of a polybiphenyl tetracarboxylic acid imide type, such as UPILEX S of Ube Industries, Ltd., and resin materials of a polybenzophenone tetracarboxylic acid imidic acid type; such as UPILEX S of Ube Industries, Ltd. and LARC-TPI (thermoplastic polyimide resin) of Mitsui Toatsu Chemicals Industry.

For a coating liquid for forming a surface-layer which includes an active energy ray curable monomer, reactive metal oxide particles, and a fluorine resin/siloxane graft type resin, it may be possible to use a polymerization initiator and a chain transfer agent which as usually used if needed.

A coating liquid for forming a surface-layer which includes an active energy ray curable monomer, reactive metal oxide particles, and a fluorine resin/siloxane graft type resin, may be prepared by the method shown hereafter.

### (Method for Preparing a Coating Liquid for Forming a Surface-Layer)

Next, a method for preparing a coating liquid for forming a surface-layer will be explained.

A coating liquid for forming a surface-layer includes 12.5 parts by volume to 400 parts by volume of the reactive metal oxide particles and 25 parts by volume to 300 parts by volume of the fluorine resin/siloxane graft type resin to 100 parts by volume of an activity energy ray curable monomer, and an amount of the reactive metal oxide particles is prepared so as to become 10 parts by volume or more and 50 parts by volume or less to the total amount of the activity energy ray curable monomer, the fluorine resin/siloxane graft type resin and the reactive metal oxide particles. Thereafter, the resultant mixture liquid is dispersed by use of a wet type media dispersing type apparatus, whereby the coating liquid for forming a surface-layer can be prepared.

The wet type media dispersing type apparatus utilized as the surface treatment apparatus in the invention is an apparatus which has a pulverizing and dispersing process that fills up with beads as a dispersion media in a container and rotates agitation disks mounted perpendicularly on a rotating shaft at high speed so as to pulverize and disperse agglomerated particles of inorganic particles by agitating them. As its structure, if an apparatus can disperse inorganic particles sufficiently at the time of conducting a surface treatment for the inorganic particles and can conduct the surface treatment, there is no problem. For example, various types, such as a vertical type or horizontal type, and a continuous type or batch type can be employable. Specifically, sand mill, Ultra visco mill, Pearl mill, Grain mill, DINO-mill, Agitator Mill, and Dynamic mill are employable. In these dispersing type apparatus, fine pulverizing and dispersing are conducted with impact crush, friction, shear force, and shear stress by the use of pulverizing media such as balls and beads.

As beads for use in the above sand grinder mill, balls made from raw materials, such as glass, alumina, zircon, zirconia, steel, flint stone, etc. can be used. However, beads made from zirconia or beads made from zircon may be especially desirable. A size of beads is usually about 1 to 2 mm, however, it is preferably 0.3 to 1.0 mm in the present invention.

As a material for a disk and an inner wall of container for use in a wet type media dispersing type apparatus, various materials such as stainless, nylon and ceramics are usable. Specifically, in the present invention, a disk and an inner wall of a container made of ceramics such as zirconia or silicon carbide are preferable.

The end point of dispersion is preferable to form such a dispersion state that when a dispersion liquid is coated on a PET film with a wire bar and the resultant coated portion is dried naturally, a change ratio in the light transmittance of the coated portion before and after on hours is 3% or less. Further, the change ratio is more preferably 1% or less.

With the above dispersion treatment, a coating liquid for forming a surface layer can be obtained.

A surface layer forming coating liquid which contains an activity energy ray curable monomer, reactive metal oxide particles, and a fluorine resin/siloxane graft type resin having a radical polymerizable unsaturated bonding parts is coated, and thereafter the coated layer is irradiated with activity energy rays so as to form a cured surface layer, whereby the following effects can be attained.

1. If a coating layer contains an activity energy ray curable monomer, reactive metal oxide particles, and a fluorine resin/siloxane graft type resin having a radical polymerizable unsaturated bonding parts, the activity energy ray curable monomer, the reactive metal oxide particles, and the fluorine resin/siloxane graft type resin having a radical polymerizable unsaturated bonding parts react with each other and bond with each other, whereby the cross-linking density becomes high, and a cured surface layer with a high hardness, a high cross-linking density, and a high toughness can be formed. As a result, the reduction of the slipping ability of the surface layer presumed to cause the separation of a fluorine resin can be prevented even though the surface layer is used for a long period of time, and further the wear resistance is improved, and flaws and scratches can be reduced.
2. Since the surface layer contains the fluorine resin/siloxane graft type resin having a radical polymerizable unsaturated bonding parts, the surface energy of the intermediate transfer belt becomes small, and the friction coefficient can be made small, so that the releasing ability for toner can be improved. AS a result, the filming resistance can be enhanced.
3. In the result that the hardness becomes high and the releasing ability for toner is improved, when toner is pressed into the intermediate transfer layer, the deformation of the surface layer of the intermediate transfer layer becomes small due to high hardness. Further, since the contact area with toner becomes small and the releasing ability for tone is improved, the sticking force between toner and the intermediate transfer layer can be reduced. As a result, a transfer ratio at the time of secondarily transferring can be improved.

### EXAMPLE

Hereafter, the present invention will explained specifically with referenced to examples. However, the present invention is not limited to these examples.

The intermediate transfer belt which had the structure of a substrate and a surface layer shown in FIG. 2 was produced by the methods shown below.

### (Preparation of an Endless Belt-Like Substrate)

Into a N-methyl-2-pyrrolidone (NMP) solution (U-varnish S: manufactured by Ube Industries (solid content: 18% by weight)) of a polyamide acid composed of 3,3′ and 4,4′-biphenyl tetracarboxylic dianhydride (BPDA) and p-phenylene diamine (PDA), dried oxidation-treated carbon black (SPECIAL BLACK4 (manufactured by Degussa Corporation, pH: 3.0, volatile content: 14.0%)) was added in an amount of 23 parts by weight to 100 parts by weight of polyimide type resin solid content. The resultant mixture was divided into two parts which were made to collide with each other with the smallest are of 1.4 mm² at a pressure of 200 MPa by use of a colliding dispersion apparatus (Geanus PY: manufactured by Geanus Corporation), and was made further to pass a passage to divide again into two parts by five times so as to be mixed, whereby a carbon black-mixed polyamide acid solution was obtained.

The carbon black-mixed polyamide acid solution was coated with a thickness of 0.5 mm on an inner surface of an cylindrical mold via a dispenser, and the cylindrical mold was rotated at 1500 rpm for 15 minutes so as to form a cylindrical layer with a uniform thickness. Successively, the cylindrical layer was applied with a heat air with a temperature of 60° C. from the outside of the mold while being rotated at 250 rpm, and then heated at 150 60° C. for 60 minutes. Thereafter, the cylindrical layer was heated to 360° C. with a temperature raising rate of 2° C./minute, and then heated at 360° C. for 30 minutes so as to remove solvent and moisture content and to make an imide conversion reaction complete. Thereafter, the cylindrical layer was cooled to room temperature and separated from the mold, whereby an endless belt-like substrate with a thickness of 0.1 mm was produced.

### (Preparation of Metal Oxide Particles)

Metal oxide particles shown in Table 1 were prepared. The number average primary particle size of metal oxide particles was obtained in such a way that an enlarged photograph of particles with a magnification of 10000 times is taken by a scanning type electron microscope, photographed images of 300 particles (except coagulated particles) are sampled randomly from the enlarged photograph by a scanner, and then the number average primary particle size is calculated from the photographed images by the use of an automatic image processing and analyzing apparatus LUZEX AP (manufactured by Nireco Corporation) with a software version of Ver.1.32.

TABLE 1

| Metal oxide | Kind of metal oxide | Particle size |
|---|---|---|
| particle No. | particles | (nm) |
| a | aluminium oxide | 34 |
| b | tin oxide | 19 |
| c | titanium oxide | 32 |
| d | silicon oxide | 29 |
| e | zinc oxide | 52 |

### (Preparation of Reactive Metal Oxide Particles)

As shown in Table 1, the kind of metal oxide particles was changed so as to prepare Metal oxide particle Nos. “a” to “e”. As compounds having a radical polymarizable functional group which treat the surface of the prepared Metal oxide particle Nos. “a” to “e”, Compound Nos. “A” to “H” were prepared.

TABLE 2

| Compound No. which has a | |
|---|---|
| radical polymarizable | Kind of a compound having a radical |
| functional group | polymarizable functional group |
| A | S-4 |
| B | S-5 |
| C | S-7 |
| D | S-13 |
| E | S-14 |
| F | S-15 |
| G | S-26 |
| H | S-30 |

Metal oxide particle Nos. “a” to “e” were subjected to surface treatment by use of Compound Nos. “A” to “H” which have a radical polymarizable functional group, whereby Reactive metal oxide particle Nos. “1-A” to “1-Q” were prepared.

TABLE 3

| | | Compound No. which has |
|---|---|---|
| Reactive metal oxide | Metal oxide particle | a radical polymarizable |
| particle (filler) No. | (filler) No. | functional group |
| 1-A | a | A |
| 1-B | a | B |
| 1-C | a | C |
| 1-D | a | D |
| 1-E | a | E |
| 1-F | a | F |
| 1-G | b | G |
| 1-H | b | H |
| 1-I | b | B |
| 1-J | b | C |
| 1-K | b | F |
| 1-L | c | A |
| 1-M | c | F |
| 1-N | d | C |
| 1-O | d | H |
| 1-P | e | C |
| 1-Q | e | E |

### [Manufacture of Reactive Metal Oxide Particles]

To 100 parts by weight of metal oxide particles, 15 parts by weight of a compound having a radical polymerizable functional group as a surface treating agent and 400 parts by weight of solvent (mixture solvent of toluene:isopropyl alcohol=1:1) were dispersed by use of a wet media dispersing apparatus, thereafter the solvent was removed, whereby reactive metal oxide particles subjected to the surface treatment with the compound having a radical polymerizable functional group were manufactured.

The surface treating amount (coating amount of the compound having a radical polymerizable functional group) of the manufactured reactive metal oxide particles with the compound having a radical polymerizable functional group was 12% by weight to the metal oxide particles.

This surface treatment amount of a compound having a radical polymerizable functional group is obtained in such a way that the metal oxide particles after the surface treatment are subjected to heat treatment at 550° C. for 3 hours, the residual components after the heat treatment are subjected to a quantitative analysis with fluorescence X rays, and the amount is obtained by molecular weight conversion from an amount of Si.

### [Preparation of Fluorine Resin/Siloxane Graft Type Resin]

### <Synthesis of Radical Polymerizable Fluorine Resin A1>

To a glass-made reactors equipped with a mechanical stirring device, a thermometer, a condenser, and a dry nitrogen introducing port, 181 parts by weight (99.6 parts by weight in solid conversion) of CEFRAL COAT A690X (nonvolatile components: 55%, manufactured by Central Glass Co., Ltd.) and 0.4 parts by weight of 2-isocyanatoethyl methacrylate were added, heated to 80° C. under the atmosphere of dry nitrogen, and allowed to react at 80° C. for 2 hours. After the disappearance of the absorption of the isocyanate was confirmed by an infrared absorption spectrum of a sample, the reaction mixture was taken out, whereby Radical polymerizable fluorine resin A1 (nonvolatile components: 55.1%) was obtained.

### <Synthesis of Radical Polymerizable Fluorine Resin A2>

Radical polymerizable fluorine resin A2 (hydroxyl value of solid content: 48, nonvolatile components: 55.1%) was obtained in the same way as that for Synthesis of Radical polymerizable fluorine resin A1 except that in place of CEFRAL COAT A690X, 99.6 parts by weight of LUMIFLON LF710F (manufactured by Asahi Glass Company) and 81.4 parts by weight of butyl acetate as a solvent were used.

<Preparation of Fluorine Resin/Siloxane Graft Type Resin Solution No. G-1)

To a glass-made reactors equipped with a mechanical stirring device, a thermometer, a condenser, and a dry nitrogen introducing port, 45 parts by weight of Radical polymerizable fluorine resin A1 (24.8 parts by weight in solid conversion), 60 parts by weight of t-butyl methacrylate, 10 parts by weight of 2-ethyl hexyl acrylate, 5 parts by weight of Sylaplane FM-0721, 5 parts by weight of Perbutyl O, 80 parts by weight of butyl acetate were added, heated to 90° C. under the nitrogen atmosphere, and allowed to react at 90° C. for 8 hours, whereby Fluorine resin/siloxane graft type resin solution No. G-1 (nonvolatile components: 50%) was obtained.

<Preparation of Fluorine Resin/Siloxane Graft Type Resin Solution Nos. G-2 to G-4)

Fluorine resin/siloxane graft type resin solution Nos. G-2 to G-4 were obtained in the same way as that for Fluorine resin/siloxane graft type resin solution No. G-1 except that the additive amount and kind of each of radical polymerizable fluorine resin, solvent, radical polymerizable monomer, and radical polymerizable polysiloxane were changed as shown in Table 4.

TABLE 4

| | Radical | Radical | | | | | | | |
|---|---|---|---|---|---|---|---|---|---|
| Fluorine resin/ | polymer- | polymer- | | | | | | | |
| siloxane graft | izable | izable | | | | | | | |
| type resin | fluorine | fluorine | | | | | | | |
| solution No. | resin A1 | resin A2 | a* | b* | c* | d* | e* | f* | g* |
| G-1 | 45 | — | 5 | — | 60 | 10 | — | 5 | 80 |
| G-2 | — | 45 | 5 | — | 60 | 10 | — | 5 | 80 |
| G-3 | — | 12 | 5 | 40 | 32 | 13 | 3 | 5 | 95 |
| G-4 | — | 12 | 20 | — | 63 | 10 | — | 5 | 95 |

a* Sylaplane FM-0721 by Chisso Corporation,
b* MMA(methyl methacrylate),
c* TBMA (t-butyl methacrylate),
d* EHA (2-ethyl hexyl acrylate),
e* HEMA (2-hydroxyethyl methacrylate),
f* Perbutyl O (t-butyl peroxy 2-ethyl ethylhexanoate) by Nippon Oil & Fats Co., Ltd.,
g* butyl acetate

### <Preparation of Commercially-Available Fluorine Resin/Siloxane Graft Type Resin>

Further, commercially-available fluorine resin/siloxane graft type resin, ZX-212 (nonvolatile components: 47%, manufactured by Fuji Chemical Industry) was prepared.

### (Preparation of Coating Liquid for Forming a Surface-Layer)

The above-prepared Reactive metal oxide particle Nos. 1-A to 1-Q, an activity energy ray curable monomer, Fluorine resin/siloxane graft type resin solution Nos. G-1 to G-4 and ZX-212, and a solvent (methyl isobutyl ketone) were mixed with combinations shown in Table 5 and Table 6, and the respective mixtures were dispersed at 1000 rpm by a transverse type circulation dispersing device (Dispennat, manufactured by Hidehiro Precision Machine) into which zirconia beads with a diameter of 0.5 mm were prepared with a filling ratio of 80%. Further, respective dispersion liquids were mixed with light polymerization initiator (IRGACURE 379, manufactured by BASF Japan), whereby Surface layer forming coating liquid Nos. 1-1 to 1-63 were prepared as shown in Table 5 and Table 6).

TABLE 5

| | | Monomer | | | | | Filler | | |
|---|---|---|---|---|---|---|---|---|---|
| Surface layer | | exemplary | | Monomer | Particles | Resin | total | Solvent | Initiator |
| forming coating | Particle | compound | | (parts by | (parts by | (parts by | amount | (parts by | (parts by |
| liquid No. | No. | No. | Resin No. | volume) | volume) | volume) | (volume %) | volume) | volume) |
| 1-1 | 1-F | 31 | ZX-212 | 100 | 12.5 | 24 | 9 | 2730 | 7 |
| 1-2 | 1-F | 31 | ZX-212 | 100 | 12.5 | 25 | 9 | 2750 | 7 |
| 1-3 | 1-F | 31 | ZX-212 | 100 | 12.5 | 50 | 8 | 3250 | 8 |
| 1-4 | 1-F | 31 | ZX-212 | 100 | 100 | 24 | 45 | 4480 | 11 |
| 1-5 | 1-F | 31 | ZX-212 | 100 | 100 | 25 | 44 | 4500 | 11 |
| 1-6 | 1-F | 31 | ZX-212 | 100 | 100 | 50 | 40 | 5000 | 13 |
| 1-7 | 1-F | 31 | ZX-212 | 100 | 100 | 100 | 33 | 6000 | 15 |
| 1-8 | 1-F | 31 | ZX-212 | 100 | 100 | 150 | 29 | 7000 | 18 |
| 1-9 | 1-F | 31 | ZX-212 | 100 | 100 | 250 | 22 | 9000 | 23 |
| 1-10 | 1-F | 31 | ZX-212 | 100 | 250 | 100 | 56 | 9000 | 23 |
| 1-11 | 1-F | 31 | ZX-212 | 100 | 250 | 150 | 50 | 10000 | 25 |
| 1-12 | 1-F | 31 | ZX-212 | 100 | 250 | 250 | 42 | 12000 | 30 |
| 1-13 | 1-F | 31 | ZX-212 | 100 | 400 | 250 | 53 | 15000 | 38 |
| 1-14 | 1-F | 31 | ZX-212 | 100 | 400 | 300 | 50 | 16000 | 40 |
| 1-15 | 1-F | 31 | ZX-212 | 100 | 400 | 400 | 44 | 18000 | 45 |
| 1-16 | 1-F | 31 | ZX-212 | 100 | 400 | 500 | 40 | 20000 | 50 |
| 1-17 | 1-F | 31 | ZX-212 | 100 | 500 | 300 | 56 | 18000 | 45 |
| 1-18 | 1-F | 31 | ZX-212 | 100 | 500 | 400 | 50 | 20000 | 50 |
| 1-19 | 1-F | 31 | ZX-212 | 100 | 11.5 | 25 | 8 | 2730 | 7 |
| 1-20 | 1-F | 31 | ZX-212 | 100 | 50 | 25 | 29 | 3500 | 9 |
| 1-21 | 1-F | 31 | ZX-212 | 100 | 150 | 25 | 55 | 5500 | 14 |
| 1-22 | 1-F | 31 | ZX-212 | 100 | 50 | 50 | 25 | 4000 | 10 |
| 1-23 | 1-F | 31 | ZX-212 | 100 | 200 | 50 | 57 | 7000 | 18 |
| 1-24 | 1-F | 31 | ZX-212 | 100 | 50 | 100 | 20 | 5000 | 13 |
| 1-25 | 1-F | 31 | ZX-212 | 100 | 200 | 100 | 50 | 8000 | 20 |
| 1-26 | 1-F | 31 | ZX-212 | 100 | 50 | 150 | 17 | 6000 | 15 |
| 1-27 | 1-F | 31 | ZX-212 | 100 | 200 | 150 | 44 | 9000 | 23 |
| 1-28 | 1-F | 31 | ZX-212 | 100 | 200 | 300 | 33 | 12000 | 30 |
| 1-29 | 1-F | 31 | ZX-212 | 100 | 300 | 300 | 43 | 14000 | 35 |
| 1-30 | 1-A | 31 | G-1 | 100 | 55 | 30 | 30 | 3700 | 9 |
| 1-31 | 1-J | 7 | G-2 | 100 | 140 | 160 | 35 | 8000 | 20 |
| 1-32 | 1-O | 12 | G-3 | 100 | 15 | 25 | 11 | 2800 | 7 |
| 1-33 | 1-B | 42 | G-1 | 100 | 200 | 140 | 45 | 8800 | 22 |
| 1-34 | 1-N | 44 | G-4 | 100 | 160 | 200 | 35 | 9200 | 23 |
| 1-35 | 1-H | 42 | G-2 | 100 | 50 | 60 | 24 | 4200 | 11 |

Particles: reactive metal oxide particles, Monomer: active energy ray curable monomer, Resin: fluorine resin/siloxane graft type resin
Solvent: methyl isobutyl ketone, Initiator: IRGACURE 379

TABLE 6

| | | Monomer | | | | | Filler | | |
|---|---|---|---|---|---|---|---|---|---|
| Surface layer | | exemplary | | Monomer | Particles | Resin | total | Solvent | Initiator |
| forming coating | Particle | compound | | (parts by | (parts by | (parts by | amount | (parts by | (parts by |
| liquid No. | No. | No. | Resin No. | volume) | volume) | volume) | (volume %) | volume) | volume) |
| 1-36 | 1-C | 7 | ZX-212 | 100 | 40 | 40 | 22 | 3600 | 9 |
| 1-37 | 1-I | 43 | G-1 | 100 | 200 | 250 | 36 | 11000 | 28 |
| 1-38 | 1-F | 31 | G-1 | 100 | 30 | 25 | 19 | 3100 | 8 |
| 1-39 | 1-C | 1 | G-3 | 100 | 25 | 125 | 10 | 5000 | 13 |
| 1-40 | 1-M | 31 | G-4 | 100 | 70 | 30 | 35 | 4000 | 10 |
| 1-41 | 1-L | 42 | ZX-212 | 100 | 150 | 240 | 31 | 9800 | 25 |
| 1-42 | 1-E | 7 | G-3 | 100 | 70 | 70 | 29 | 4800 | 12 |
| 1-43 | 1-C | 12 | G-2 | 100 | 100 | 25 | 44 | 4500 | 11 |
| 1-44 | 1-P | 31 | G-1 | 100 | 30 | 30 | 19 | 3200 | 8 |
| 1-45 | 1-G | 1 | G-4 | 100 | 150 | 240 | 31 | 9800 | 25 |
| 1-46 | 1-D | 7 | ZX-212 | 100 | 300 | 270 | 45 | 13400 | 34 |
| 1-47 | 1-K | 44 | G-3 | 100 | 50 | 40 | 26 | 3800 | 10 |
| 1-48 | 1-A | 7 | G-4 | 100 | 70 | 80 | 28 | 5000 | 13 |
| 1-49 | 1-Q | 42 | G-1 | 100 | 400 | 300 | 50 | 16000 | 40 |
| 1-50 | 1-J | 43 | G-2 | 100 | 180 | 245 | 34 | 10500 | 26 |
| 1-51 | 1-F | 44 | ZX-212 | 100 | 40 | 40 | 22 | 3600 | 9 |
| 1-52 | 1-J | 31 | G-1 | 100 | 10 | 25 | 7 | 2700 | 7 |
| 1-53 | 1-F | 7 | G-2 | 100 | 80 | 10 | 42 | 3800 | 10 |
| 1-54 | 1-C | 12 | ZX-212 | 100 | 50 | 800 | 5 | 19000 | 48 |
| 1-55 | — | 31 | ZX-212 | 100 | — | 100 | 0 | 4000 | 10 |
| 1-56 | — | 31 | G-1 | 100 | — | 200 | 0 | 6000 | 15 |
| 1-57 | 1-A | — | G-1 | — | 40 | 100 | 29 | 2800 | 7 |
| 1-58 | 1-A | 31 | — | 100 | 30 | — | 23 | 2600 | 7 |
| 1-59 | 1-F | — | G-1 | — | 100 | 100 | 50 | 4000 | 10 |
| 1-60 | 1-C | 7 | — | 100 | 20 | — | 17 | 2400 | 6 |
| 1-61 | 1-C | — | ZX-212 | — | 100 | 300 | 25 | 8000 | 20 |
| 1-62 | — | 7 | ZX-212 | 100 | — | 40 | 0 | 2800 | 7 |
| 1-63 | 1-F | 31 | — | 100 | 5 | — | 5 | 2100 | 5 |

Particles: reactive metal oxide particles, Monomer: active energy ray curable monomer, Resin: fluorine resin/siloxane graft type resin
Solvent: methyl isobutyl ketone, Initiator: IRGACURE 379

### (Coating of Coating Liquid for Forming a Surface Layer)

On the surface of the prepared endless belt-like substrate, each of Surface layer forming coating liquid Nos. 1-1 to 1-63 was coated with an immersion coating method by use of a coating apparatus shown in FIG. 4, so that a coating layer for forming a surface layer was formed with a dried layer thickness of 2 μm. Thereafter, the respective coating layers were cured with Ultraviolet rays as active energy rays by the cure processing device shown in FIG. 4 so as to form a cured surface layer, whereby the intermediate transfer belts were produced and made Sample Nos. 101 to 163.

At the time of irradiation of Ultraviolet rays, the light source was fixed, and a cylindrical substrate holing the intermediate transfer belt was rotated at 60 mm/s.

### Coating Conditions

Coating liquid supply amount: 1 l/min

Raising speed: 4.5 mm/min

### UV Irradiation Conditions

Kind of light source: High pressure mercury lamp
(H04-LA41: manufactured by I-Graphics Co.)

Distance from an irradiation port to the surface of the coating layer: 100 mm

Amount of irradiation light: 1 J/cm2

Irradiation time (time for rotaint the substrate): 240 seconds

### Evaluation

The above-produced Sample Nos. 101 to 163 were evaluated in terms of Transfer ratio, Flaw resistance, Wear resistance, and Filming resistance with regard to durability by the following procedures, and the results of evaluation in accordance with the following evaluation ranks are shown in Table 7 and Table 8.

### <Evaluation Method of Transfer Ratio>

The produced intermediate transfer belts were respectively mounted on the evaluation machine in which bizhub PRO C6500 (tandem color compound machine: laser exposure, reversal development, intermediate transfer member) manufactured by Konica Minolta Business Technologies Inc. was modified so as to conduct evaluation and an amount of exposure was adjusted, and then image formation was conducted so as to transfer an A-4 size image with a printing ratio of 100% of a cyan color from the respective intermediate transfer belt onto a neutralized paper.

Toner was sampled from the predetermined area (three points each with a size of 10 mm×50 mm) on the intermediated transfer belt by use of a suction unit and a toner weight (A) before the transferring was measured.

Next, toner remaining on the intermediated transfer belt after the transferring was sampled by a bukker tape, and pasted on a white paper sheet. The toner on the white paper sheet was subjected to color measurement by use of a spectrum colorimeter (CM-2002, manufactured by Konica Minolta Sensing Corp.) and a toner weight (B) remaining after the transferring was obtained from the relationship between the color measurement value and the toner weight which was predetermined as a calibration curve.

The transfer ratio (η) was determined by the following formula.

η=(1−B/A)×100(%)

Evaluation rank of the transfer ratio

A: A transfer ratio is 98% or more to 100%.

B: A transfer ratio is 95% or more and less than 98%.

C: A transfer ratio is 90% or more and less than 95%.

D: A transfer ratio is less than 90%.

The valuation method of crack-proof nature

### <Evaluation Method of Flaw Resistance>

The produced intermediate transfer belts were respectively mounted on the evaluation machine in which bizhub PRO C6500 (tandem color compound machine: laser exposure, reversal development, intermediate transfer member) manufactured by Konica Minolta Business Technologies Inc. was modified so as to conduct evaluation and an amount of exposure was adjusted, and then image formation was conducted so as to transfer an A-4 size image with a printing ratio of 25% of each color of YMCK from the respective intermediate transfer belt onto 1000,000 sheets of neutralized paper. Thereafter, the surface of the intermediate transfer belt was observed, and the flaw state occurred in a range of 100 mm×100 mm was evaluated.

Evaluation rank of flaw resistance
A: No flaw occurred after the printing of 1000,000 sheets
B: Flaws occurred at one or more places and less than six places after the printing of 1000,000 sheets
C: Flaws occurred at six places or more and less than eleven places after the printing of 1000,000 sheets
D: Flaws occurred at eleven places or more after the printing of 1000,000 sheets

### <Evaluation Method of Wear Resistance>

In the same way as that in Evaluation method of flaw resistance image formation was conducted for 1000,000 sheets. Then, the wear resistance was evaluated based on the film thickness of the intermediate transfer belt at the initial stage and the film thickness of the intermediate transfer belt after the printing of 1000,000 sheets. The film thickness of the intermediate transfer belt was measure at ten points randomly on a film thickness uniform portion (except both ends and portions located within 3 cm from the both ends where the film thickness may not be uniform), and the average values of ten measurements was made a film thickness of the intermediate transfer belt. The film thickness was measured by an eddy current type film thickness measuring device EDDY 560C (manufactured by HELMUT FISCER GMBTE Corp.), and a difference in film thickness of the intermediate transfer belt before and after the actual printing test was made as a film thickness wear-down amount.

Evaluation rank of wear resistance

A: A thickness wear-down amount was less than 0.5 μm

B: A thickness wear-down amount is 0.5 μm or more and less than 1 μm.

C: A thickness wear-down amount is 1 μm or more and less than 2 μm.

D: A thickness wear-down amount is 2 μm or more.

### <Evaluation Method of Filming Resistance>

In the same way as that in Evaluation method of flaw resistance, image formation was conducted for 1000,000 sheets and the filming resistance was evaluated with color difference between the initial stage and after the printing of 1000,000 sheets. The intermediate transfer belt was subjected to color measurement by use of a spectrum colorimeter (CM-2002, manufactured by Konica Minolta Sensing Corp.), and ΔE was calculated.

Evaluation rank of filming resistance

A: ΔE was 0 or more and less than 1.

B: ΔE was 1 or more and less than 4.

C: ΔE was 4 or more and less than 6.

D: ΔE was 6 or more.

TABLE 7

| | Surface layer | | | | | |
|---|---|---|---|---|---|---|
| | forming | Trans- | Flaw | Wear | Filming | |
| Sample | coating | fer | resis- | resis- | resis- | |
| No. | liquid No. | ratio | tance | tance | tance | Remarks |
| 101 | 1-1 | B | C | C | C | Invention |
| 102 | 1-2 | B | C | C | C | Invention |
| 103 | 1-3 | C | C | C | B | Invention |
| 104 | 1-4 | A | A | A | C | Invention |
| 105 | 1-5 | A | B | B | B | Invention |
| 106 | 1-6 | A | A | A | A | Invention |
| 107 | 1-7 | B | A | A | A | Invention |
| 108 | 1-8 | B | B | B | A | Invention |
| 109 | 1-9 | B | B | B | A | Invention |
| 110 | 1-10 | B | A | B | C | Invention |
| 111 | 1-11 | A | A | A | A | Invention |
| 112 | 1-12 | B | A | A | A | Invention |
| 113 | 1-13 | B | A | A | C | Invention |
| 114 | 1-14 | B | A | A | A | Invention |
| 115 | 1-15 | B | C | C | A | Invention |
| 116 | 1-16 | B | C | C | A | Invention |
| 117 | 1-17 | B | B | A | C | Invention |
| 118 | 1-18 | C | B | B | A | Invention |
| 119 | 1-19 | B | C | C | C | Invention |
| 120 | 1-20 | A | B | B | B | Invention |
| 121 | 1-21 | A | A | C | B | Invention |
| 122 | 1-22 | A | A | B | B | Invention |
| 123 | 1-23 | A | A | C | B | Invention |
| 124 | 1-24 | B | B | B | B | Invention |
| 125 | 1-25 | B | A | A | A | Invention |
| 126 | 1-26 | B | B | B | A | Invention |
| 127 | 1-27 | B | B | B | A | Invention |
| 128 | 1-28 | B | B | B | A | Invention |
| 129 | 1-29 | B | A | B | A | Invention |
| 130 | 1-30 | A | A | A | B | Invention |
| 131 | 1-31 | B | B | B | A | Invention |
| 132 | 1-32 | B | B | B | B | Invention |
| 133 | 1-33 | A | B | A | A | Invention |
| 134 | 1-34 | A | B | B | A | Invention |
| 135 | 1-35 | B | B | B | B | Invention |
| 136 | 1-36 | A | A | A | B | Invention |
| 137 | 1-37 | B | B | B | A | Invention |
| 138 | 1-38 | A | B | B | B | Invention |
| 139 | 1-39 | B | B | B | A | Invention |
| 140 | 1-40 | A | A | A | B | Invention |

TABLE 8

| | Surface layer | | | | | |
|---|---|---|---|---|---|---|
| | forming | Trans- | Flaw | Wear | Filming | |
| Sample | coating | fer | resis- | resis- | resis- | |
| No. | liquid No. | ratio | tance | tance | tance | Remarks |
| 141 | 1-41 | B | B | B | A | Invention |
| 142 | 1-42 | B | B | B | B | Invention |
| 143 | 1-43 | A | A | A | B | Invention |
| 144 | 1-44 | A | B | B | B | Invention |
| 145 | 1-45 | B | B | B | A | Invention |
| 146 | 1-46 | B | B | A | A | Invention |
| 147 | 1-47 | A | A | A | B | Invention |
| 148 | 1-48 | B | B | B | B | Invention |
| 149 | 1-49 | B | B | B | A | Invention |
| 150 | 1-50 | B | B | B | A | Invention |
| 151 | 1-51 | B | A | A | B | Invention |
| 152 | 1-52 | B | C | C | B | Invention |
| 153 | 1-53 | B | A | C | B | Invention |
| 154 | 1-54 | C | C | C | B | Invention |
| 155 | 1-55 | C | D | D | C | Comparative |
| 156 | 1-56 | C | D | D | B | Comparative |
| 157 | 1-57 | C | D | D | B | Comparative |
| 158 | 1-58 | B | C | B | D | Comparative |
| 159 | 1-59 | C | D | D | B | Comparative |
| 160 | 1-60 | B | C | B | D | Comparative |
| 161 | 1-61 | D | D | D | C | Comparative |
| 162 | 1-62 | C | D | D | C | Comparative |
| 163 | 1-63 | C | D | C | D | Comparative |

Sample Nos. 101 to 121 were formed in such a way that a surface layer forming coating liquid which includes an activity energy ray curable monomer, reactive metal oxide particles, and a fluorine resin/siloxane graft type resin having a radical polymerizable unsaturated bonding parts was coated, and the resultant coating layer was irradiated with active energy rays so as to cure the activity energy ray curable monomer and the coating layer so that the cured surface layer was formed. As a result, it was confirmed that Sample Nos. 101 to 121 were excellent in any item of Transfer ratio, Wear resistance, and Flaw resistance.

Further, it was confirmed that Sample Nos. 158, 160, and 163 which included a surface layer composed of an activity energy ray curable monomer and reactive metal oxide particles were inferior in Filming resistance as compared with Sample Nos. 111, 130 and 136 according to the present invention.

Further, it was confirmed that Sample Nos. 157, 159, and 161 which included reactive metal oxide particles and a fluorine resin/siloxane graft type resin having a radical polymerizable unsaturated bonding parts were inferior in Flaw resistance and Wera resistance as compared with Sample Nos. 130, 138 and 154 according to the present invention.

Further, it was confirmed that S ample Nos. 155, 156, and 162 which included an activity energy ray curable monomer and a fluorine resin/siloxane graft type resin having a radical polymerizable unsaturated bonding parts were inferior in Flaw resistance as compared with Sample Nos. 101 to 130, 136, 138, 144, 146, and 152 according to the present invention.

Incidentally, from another aspect of the present invention, the above-mentioned preferable embodiments of the present invention can be summarized as follows. As a result, the effectiveness of the present invention was confirmed.

1. In a method of producing an intermediate transfer belt which includes at least one surface layer on a substrate and is used in an image forming apparatus of an electro-photographing type, the method of producing an intermediate transfer belt is characterized in that the surface layer is formed in such a way that a surface layer forming coating liquid which includes an active energy ray curable monomer, reactive metal oxide particles, and a fluorine resin/siloxane graft type resin having radical polymerizable unsaturated bonding parts, is coated, and then the coating layer is irradiated with active energy rays.
2. The method of producing an intermediate transfer belt described in 1, is characterized in that the surface layer forming coating liquid contains 12.5 parts by volume to 400 parts by volume of the reactive metal oxide particles and 25 parts by volume to 300 parts by volume of the fluorine resin/siloxane graft type resin to 100 parts by volume of an activity energy ray curable monomer, and an amount of the reactive metal oxide particles is 10 parts by volume or more and 50 parts by volume or less to the total amount of the activity energy ray curable monomer, the fluorine resin/siloxane graft type resin and the reactive metal oxide particles.
3. In an intermediate transfer belt which includes at least one surface layer on a substrate and is used in an image forming apparatus of an electro-photographing type, the intermediate transfer belt is characterized in that the surface layer is formed by the producing method described in 1 or 2.
4. An image forming apparatus is characterized by employing the intermediate transfer belt described in 3.

It become possible to provide an intermediate transfer belt which has a surface layer excellent in transfer ratio at the time of the secondarily transferring, durability such as wear resistance and flaw resistance against removing of toner by a cleaning member after the secondarily transferring, and filming resistance; an image forming apparatus; and a method of producing the intermediate transfer belt

What is claimed is:

1. An intermediate transfer belt for use in an image forming apparatus of an electro-photographing type, comprising:
a substrate; and
a surface-cured layer provided on the substrate;
wherein the surface-cured layer contains a reaction product of at least an active energy ray curable monomer, reactive metal oxide particles, and a graft copolymer of a polymerizable fluorine resin and a polymerizable siloxane.

2. The intermediate transfer belt described in claim 1, wherein the cured surface layer has a hardness of 0.5 GPa to 2.5 GPa according to a nano-indentation method.

3. The intermediate transfer belt described in claim 1, wherein the cured surface layer has a thickness of 0.5 μm to 5 μm.

4. The intermediate transfer belt described in claim 1, wherein the cured surface layer has a friction coefficient of 0.25 or less.

5. The intermediate transfer belt described in claim 1, wherein the cured surface layer contains 12.5 parts by volume to 400 parts by volume of the reactive metal oxide particles and 25 parts by volume to 300 parts by volume of the graft copolymer to 100 parts by volume of the activity energy ray curable monomer.

6. The intermediate transfer belt described in claim 1, wherein the cured surface layer contains 10% by volume or more and 50% by volume or less of the reactive metal oxide particles to the total amount of the activity energy ray curable monomer, the graft copolymer and the reactive metal oxide particles.
